(19) United States
(12) Patent Application Publication
(10) Pub. No.: US 2025/0243707 A1
(43) Pub. Date: Jul. 31, 2025

(54) Modular Headrail-Mounted Automation System for Wand-Operated Window Blinds

(71) Applicant: Pradeep Pranjivan Popat, Arlington, VA (US)

(72) Inventor: Pradeep Pranjivan Popat, Arlington, VA (US)

(21) Appl. No.: 18/823,597

(22) Filed: Sep. 3, 2024

Related U.S. Application Data
(60) Provisional application No. 63/581,672, filed on Sep. 10, 2023.

(51) Int. Cl. E06B 9/322; E06B 9/24; H02S 10/40; H02S 20/26

(52) U.S. Cl. CPC E06B 9/322; H02S 10/40; H02S 20/26; E06B 2009/2476

(57) ABSTRACT

A modular headrail-mounted automation system for wand-operated horizontal blinds optionally includes a main module with two bilaterally-disposed interfaces to auxiliary modules or cables. Optionally, the system includes a photovoltaic panel whose photosensitive surface is located on the room side of the host blind and faces the host blind's slats. Optionally, the system includes a controller to tilt the slats of the host blind over a range in which the maximum amount of slat closure is reduced when the system is powered by a photovoltaic source. Optionally, the maximum amount of slat closure is dependent upon the level of charge in an energy-storage device charged by a photovoltaic source.

### CROSS-REFERENCE TO RELATED APPLICATIONS

Not Applicable

### FEDERALLY SPONSORED RESEARCH AND DEVELOPMENT

Not Applicable

### REFERENCE TO A “SEQUENCE LISTING”, A TABLE, OR A COMPUTER PROGRAM LISTING APPENDIX SUBMITTTED ON A COMPACT DISC AND AN INCORPORATION-BY-REFERENCE OF THE MATERIAL ON THE COMPACT DISC

Not Applicable

### BACKGROUND OF THE INVENTION

The subject invention is in the field of devices to automate adjustable window coverings having headrails, such as blinds and shades.

The most widely-used headrail-type window covering amenable to automation with a headrail-mounted device is the wand-operated horizontal blind. FIG. 1 shows such a wand-operated blind 20. Blind 20 covers a window (not shown) in a room (not shown) with an array of horizontal slats 21. The surface of the window (not shown) is in the X-Z plane of the depicted reference coordinate system, with X representing the horizontal (width) axis and Z representing the vertical (height) axis. When mounted on a host window, blind 20 has two sides in the X-Z plane: a room side (i.e. the side visible in the perspective view of FIG. 1), and a window side (which is not visible in the perspective view of FIG. 1).

Headrail 22 is in the shape of a long, narrow box (typically with an open top), with its long axis aligned with the X-axis. Because headrail 22 spans the entire width of the slats, it is typically made of steel to provide the necessary rigidity. Headrail 22 encloses an internal tilt rod (not shown) which spans most of the width of the headrail, and from which slats 21 are suspended.

The internal tilt rod (not shown) is rotated about the X-axis by a tilter mechanism 23, also inside headrail 22, which in turn is actuated by a control shaft 24. Control shaft 24 protrudes from a front 25 of headrail 22 and suspends a control wand 26, which enables a user to conveniently rotate control shaft 24 about the Z-axis and thereby adjust the tilt angle of slats 21 about the X-axis.

Notably, while control shaft 24 protrudes from the right side (along the X-axis) of headrail 22 of blind 20, in some blinds the control shaft protrudes from the left side.

Headrail 22 has a pair of end-caps, an end-cap 27 on one side, and another end-cap (not shown) on the opposite side.

A horizontal blind such as blind 20 will also include a lifting mechanism (typically actuated by a lifting cord) to raise the slats along the Z-axis; the lifting cord is omitted from FIG. 1 for clarity.

A system for automating a blind such as blind 20 will necessarily include at least one motorization element (to motorize either the slat-tilt or slat-lift function, or both the slat-tilt and slat-lift functions), and optionally power, sensor, control, and communications elements to complement the motorization element.

Motorization approaches for both the slat-tilt and slat-lift functions of blinds such as blind 20 are well-established in the art. However, the slat-tilt function is far less complex and expensive to motorize than the slat-lift function, and is therefore the object of most blind-automation systems in the marketplace.

Some slat-tilt motorization devices are contained within the host blind's headrail, e.g. headrail 22 of FIG. 1, but these are relatively expensive and difficult to install. The same is true for other automation elements (e.g. power sources and sensors) to complement the motorization device

Accordingly, motorization devices which can be installed externally to the host headrail are increasingly popular; such devices rotate the host blind's control shaft (e.g. shaft 24 of FIG. 1) or control wand (e.g. wand 26) to adjust the slat tilt. Such devices are referred to herein as external motorization devices.

Such devices can be attached directly to the host blind (referred to herein as on-blind devices), or can be mounted on the wall or window frame adjacent to the host blind (referred to herein as off-blind devices). Because on-blind devices are generally much easier to install, they are gaining favor in the marketplace, and are the focus of this disclosure.

On-blind motorization devices can be grouped into two categories: wand-type devices and headrail-mounted devices.

A wand-type motorization device has a tubular form-factor that generally mimics the shape of a manual control wand (e.g. wand 26 of FIG. 1), albeit with a necessarily larger diameter, and includes a motor that is coupled to the host blind's control shaft (e.g. shaft 24). Like a manual control wand, it is suspended vertically from the control shaft, but also includes a bracket or tab that physically contacts the headrail, window frame, or wall to react the torque produced by the motor. An early example of a wand-type automation device is disclosed in U.S. Pat. No. 5,603,371.

The wand form-factor has a significant advantage for motorization devices which are powered by primary batteries: the batteries can be mounted near the bottom of the wand where they can be reached for replacement without need for a stool or step-ladder. However, the wand form-factor also has three disadvantages.

First, when using hardwired power (such as from a transformer or photovoltaic source), the power wiring is visible. This is also true of any wiring between the automation device and other devices, such as a window-mounted sensor or photovoltaic panel.

Second, because a wand-type device is suspended from the control shaft and not rigidly attached to the headrail, it generally sways visibly with each motor revolution.

Third, the small-diameter cylindrical form-factor complicates the packaging of components such as sensors, switches, indicators, RF transceivers, increasing cost and limiting the achievable functionality.

In contrast to wand-type devices, the second type of external motorization device, the headrail-mounted device, is typically attached rigidly to the headrail, includes some form of floating motor-mount to accommodate variations in the design of the host blind, and includes a housing that conceals the coupling between the motor and the control shaft. An early example of a headrail-mounted motorization device is disclosed in U.S. Pat. No. 5,760,558. Headrail-mounted devices offer three significant advantages over wand-type devices.

First, their form-factor affords greater freedom for component selection and packaging, reducing cost and allowing greater functionality.

Second, due to the rigid mounting to the headrail, there is typically negligible visible movement of the device during operation.

Finally, the housing can partially conceal hardwiring to a complementary automation device, e.g., a power source or sensor.

While the above advantages are compelling form many applications, headrail-mounted devices must contend with an issue that does not apply to wand-type devices: the effects of “headrail lean”. Referring again to FIG. 1, blinds are intended to be installed so that the front of the headrail (e.g. headrail front 25) is parallel to the X-Z plane. However, in a large fraction of installed blinds, the front surface of the headrail has a noticeable lean with respect to the X-Z plane, i.e. the plane of the window.

While headrail lean has no effect on the operation of the blind, it can be an issue for any device which is rigidly attached to the headrail, because it can reduce the Y-axis distance between the bottom of such a device and the blind's slats. In fact, depending on the height (i.e. the Z-dimension) of the device and the amount of headrail lean, the bottom of the device can actually come in contact with the slats, potentially interfering with the blind's operation.

The Y-axis distance between the Center of Gravity (CG) of a headrail-mounted device and the front of the headrail (e.g. headrail front 25) constitutes a lever arm that—together with the weight of the device—applies rotational torque to the headrail. Even if the front surface of the headrail is perfectly parallel to the X-Z plane prior to the device's installation, this torque can sometimes induce enough headrail lean to cause interference between the bottom of the device and the window covering.

Thus, to avoid potential issues with headrail lean, there are constraints on the height, weight, and Y-axis location of the CG of any headrail-mounted device, which in turn constrains the amount of functionality which can be included in the device.

This functionality constraint cannot be avoided by increasing the width (i.e. the X-axis dimension) of the device, because many blinds are mounted with the headrails inside a window frame. In order to fit into the window frame, a headrail-mounted device cannot extend along the X-axis beyond the proximal edge of the headrail (or, if the headrail has an end-cap such as cap 27 of FIG. 1, beyond the edge of the proximal end-cap). Thus, since a blind's control shafts can be located on either side of the headrail (depending on the blind's design), a headrail-mounted motorization device's width cannot be greater than twice the minimum expected X-axis distance between the center of the control shaft and the proximal edge of the headrail (or proximal edge of the end-cap, if present).

In addition to constraints on height, width, weight, and CG location, on-headrail motorization devices also face a challenge faced by many types of automation devices in today's marketplace: market fragmentation.

For example, the market is fragmented according to the type of power source that buyers are willing to accept. For residential buyers interested in cost-effective “do-it-yourself” automation, the need for mains-derived power can be a significant disadvantage, so battery power is typically preferred. On the other hand, the need for periodic battery charging or replacement is a disadvantage for commercial and institutional buyers, so they often prefer mains-derived power despite the greater installation cost. Photo-Voltaic (PV) power can eliminate the need for battery replacement and mains-derived power, but the added cost and installation complexity of a PV panel and the associated wiring is a disadvantage of some potential buyers. This problem is partially addressed in the disclosure of U.S. Pat. No. 5,760,558, which shows a PV-powered, headrail-mounted automation device for venetian blinds. Instead of using a separate window-mounted PV panel, the 5,760,558 device integrates a PV power source on a thin flexible strip. During installation, the strip is intended to be passed above the headrail and then slipped between the host headrail and the window frame, thereby positioning the PV sensitive area proximal to and facing the window and eliminating the need for a separate PV panel. However, if the headrail fits tightly against the ceiling, wall, window frame, or window (as is the case in many blind installations), then the blind must first be removed before the device can be installed on the host blind, drastically increasing the installation effort relative to a conventional window-mounted PV panel.

Yet another source of market fragmentation arises from differing requirements for automation capability. To meet the needs of some potential buyers, an automation system must be capable of fully autonomous automatic operation without need being connected to a home-automation hub or building-management system. This can necessitate the inclusion of onboard sensors for illumination, temperature, or room occupancy. However, such features can be superfluous for buyers who need only remote-controlled motorized operation, or who intend to rely on a home-automation hub or building-management system for automation “intelligence”.

Due to this fragmentation in market requirements, designers of automated shading products are forced to choose between omitting features demanded by particular market segments, accepting the increased cost of features that are potentially superfluous in other market segments, or accepting the logistics costs of producing and distributing multiple products with different feature sets.

In summary, while headrail-mounted automation devices for wand-operated blinds offer compelling advantages, conventional headrail-mounted motorization devices suffer from constraints on size and weight. Further, fragmentation in market requirements forces a choice between accepting the logistics costs of producing and distributing multiple headrail-mounted automation products to address diverse market segments, or else offering a headrail-mounted automation product whose feature set may be sub-optimal for some market segments.

### SUMMARY OF THE INVENTION

The subject invention is a modular headrail-mounted automation system for wand-operated horizontal blinds. An embodiment includes a main module which includes elements necessary to provide a default level of functionality (e.g. a motor, motor-control circuitry, and a microcontroller), two bilaterally-disposed interfaces to receive power from and optionally communicate with another device, a ribbon-cable connector to interface with another device, and a daughter-card connector to mate with an optional daughter-card to provide additional functionality (e.g. an RF transceiver for wireless connectivity).

The main module is configured to mount on the room side of the headrail of the host blind. An optional power module is also configured to mount on the room side of the headrail to supply power to (and optionally communicate with) the main module via one of the latter's bilaterally-disposed interfaces, and can thus be mounted on either the right side or the left side of the main module as desired or as required by the design of the host blind.

Optionally, power can be provided to the main module, and the main module's functionality can be augmented, via an external device connected to the ribbon-cable connector.

Optionally, either the main or power module includes a photovoltaic panel whose photosensitive surface is located on the room side of the host blind and faces the host blind's slats. Optionally, the system includes a controller to tilt the slats of the host blind over a range in which the maximum amount of slat closure is reduced when the system is powered by a photovoltaic source. Optionally, the maximum amount of slat closure is dependent upon the level of charge in an energy-storage device charged by a photovoltaic source.

This configuration minimizes the size and cost of the main module while enabling it to be powered from a variety of sources—and its functionality to be conveniently augmented to address diverse market segments—via one or more auxiliary modules, while avoiding potential issues with headrail lean that might result if the same functionality were incorporated into the main module.

### BRIEF DESCRIPTION OF DRAWINGS

FIG. 1 (prior art) is a perspective view of a conventional wand-operated horizontal blind.

FIG. 2 is a block diagram of a preferred embodiment of a main module.

FIG. 3 is left-front perspective view of a preferred embodiment of a main module.

FIG. 4 is a right-front perspective view of a preferred embodiment of a main module.

FIG. 5 is a right-front perspective view of a preferred embodiment of a main module mounted on a host blind and receiving power via a ribbon cable mated to a top connector.

FIG. 6 is a right-front perspective view of a preferred embodiment of a main module mounted on a host blind and receiving power via a cable mated to a right magnetic connector.

FIG. 7 is a block diagram of a preferred embodiment of a battery module.

FIG. 8 is left-front perspective view of a preferred embodiment of a battery module.

FIG. 9 is a right-rear perspective view of a preferred embodiment of a battery module.

FIG. 10 is a right front perspective view of preferred embodiments of a main module and a battery module mounted on the right side of the headrail of a host blind.

FIG. 11 is a right front perspective view of preferred embodiments of a main module and a battery module mounted on the left side of the headrail of a host blind.

FIG. 12 is a block diagram of a preferred embodiment of a solar power module.

FIG. 13 is left-front perspective view of a preferred embodiment of a solar power module.

FIG. 14 is a right-rear perspective view of a preferred embodiment of a solar power module.

FIG. 15 is a right front perspective view of preferred embodiments of a main module and a solar power module mounted on the right side of the headrail of a host blind.

FIG. 16 is a right front perspective view of preferred embodiments of a main module and a solar power module mounted on the left side of the headrail of a host blind.

FIG. 17 is a side view of a horizontal blind on a window in a room, with a photovoltaic panel on the room side of the blind facing the blind's slats.

FIG. 18A is a cross-sectional view of a slat of a horizontal blind in the open position.

FIG. 18B is a cross-sectional view of a slat of a horizontal blind in a first closed position.

FIG. 18C is a cross-sectional view of a slat of a horizontal blind in a second closed position.

FIG. 19 is a flowchart of operating steps to modify the slat-tilt limits (and hence maximum amount of slat closure) to maximize the energy produced by a photovoltaic power source located on the room side of a blind.

FIG. 20 is a flowchart of operating steps to modify the slat-tilt limits (and hence maximum amount of slat closure) as a function of the energy stored in an energy-storage device which is charged by a photovoltaic source.

FIG. 21 is a left-front perspective view of a preferred embodiment of a battery module with only a single power interface.

FIG. 22 is a right-front perspective view of a preferred embodiment of a battery module with only a single power interface.

FIG. 23 is a block diagram showing the modules in a first preferred family of automation modules in which auxiliary modules provide only power.

FIG. 24 is a block diagram showing the modules in a second preferred family of automation modules in which a solar power module provides peripherals functionality in addition to power.

FIG. 25 is a block diagram of an alternative preferred embodiment of a solar-power module with peripherals functionality.

FIG. 26 is a block diagram showing the modules in a third preferred family of automation modules in which peripherals functionality is provided by a dedicated auxiliary module.

FIG. 27 is a block diagram of a preferred embodiment of a peripherals module.

FIG. 28 is a right front perspective view of preferred embodiments of a peripherals module mated with a battery module and a main module, with the peripherals module receiving power from the right side.

FIG. 29 is a right front perspective view of preferred embodiments of a peripherals module mated with a battery module and a main module, with the peripherals module receiving power from the left side.

FIG. 30 is a right front perspective view of preferred embodiments of a peripherals module mated with a solar power module and a main module, with the peripherals module receiving power from the right side.

FIG. 31 is a right front perspective view of preferred embodiments of a peripherals module mated with a solar power module and a main module, with the peripherals module receiving power from the left side.

FIG. 32 is a block diagram showing the modules in a fourth preferred family of automation modules in which all modules include a solar power supply.

FIG. 33 is a block diagram of a preferred embodiment of a main module with integral solar power supply.

FIG. 34 is a block diagram of a preferred embodiment of a peripherals module with integral solar power supply.

FIG. 35 is a flowchart of operating steps to enable and disable autonomous operation of an automation device based on the presence of a peripherals module.

FIG. 36 is a front view of a preferred embodiment of a main module with alternative connectors.

FIG. 37 is a right front perspective view of a preferred embodiment of a main module with alternative connectors.

FIG. 38 is a front view of a preferred embodiment of a solar power module with alternative connectors.

FIG. 39 is a rear view of a preferred embodiment of a solar power module with alternative connectors.

FIG. 40 is a right front perspective view of a preferred embodiment of a solar power module with alternative connectors.

FIG. 41 is a right front perspective view of preferred embodiments of a main module and solar power module with alternative connectors mounted on the right side of the headrail of a host blind.

FIG. 42 is a right front perspective view of preferred embodiments of a main module and solar power module with alternative connectors mounted on the left side of the headrail of a host blind.

FIG. 43 is a block diagram of a preferred embodiment of a wireless power transmitter.

FIG. 44 is a block diagram of a preferred embodiment of a wireless power receiver.

FIG. 45 is a block diagram of a preferred embodiment of a main module for use with a removable solar power module.

FIG. 46 is a block diagram of a preferred embodiment of a removable solar power module for use with a main module.

FIG. 47 is a right rear perspective view of a preferred embodiment of a main module for use with a removable solar power module.

FIG. 48 is a rear view of a preferred embodiment of a main module for use with a removable solar power module.

FIG. 49 is a right front perspective view of a preferred embodiment of a removable solar power module for use with a main module.

FIG. 50 is a left rear perspective view of a preferred embodiment of a removable solar power module for use with a main module.

FIG. 51 is a right rear perspective view of a preferred embodiment of a main module to which a preferred embodiment of a removable solar power module has been attached.

### DETAILED DESCRIPTION OF THE INVENTION

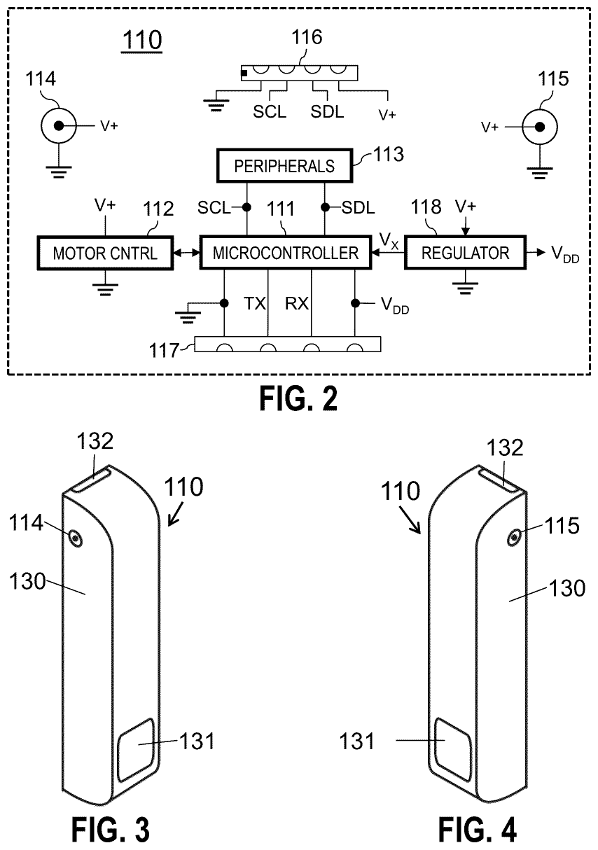

Automation Main Module 110. FIG. 2 shows a block diagram of the electronic portion of a preferred embodiment of the subject invention, a main automation module 110. As will be subsequently described, main module 110 is configured to provide a default level of automation functionality for a conventional wand-operated venetian blind.

Main module 110 includes a microcontroller 111, a motor controller 112, a peripheral subsystem 113, a left interface 114, a right interface 115, a top connector 116, a daughter-card connector 117, and a voltage regulator 118.

Interfaces 114 and 115 and connector 116 accept power from an external source and provide it to the other elements of module 110 via V+ and ground terminals. Regulator 118 is a conventional voltage regulator which regulates the V+ voltage to produce a lower voltage V_{DD} for use by microcontroller 111 and peripherals subsystem 113, and which also includes a buffered voltage divider to produce a sense voltage V_{X} which is proportional to the unregulated V+.

Microcontroller 111 is a conventional microcontroller which includes two serial interfaces (one compliant with the Inter-Integrated Circuit (I2C) standard and one compliant with the TTL serial standard) and an Analog-to-Digital Converter (ADC) input. The I2C interface, which comprises a ground signal, a Serial Data Line (SDL), and a Serial Clock Line SCL) is connected in parallel to connector 116 and peripherals subsystem 113. The TTL serial interface is connected to daughter-card connector 117. The ADC input (not labeled in FIG. 2) is connected to the sense voltage V_{X} output of regulator 118 to enable microcontroller 111 to monitor input voltage V+, which could exceed the voltage limits of the ADC input.

Motor controller 112 is a conventional motor controller configured to control a DC gear-motor in response to commands from microcontroller 111, to track the angular displacement of the gear-motor's output shaft (e.g. via a Hall-effect incremental encoder), and to provide angular displacement information back to microcontroller 111.

Peripheral subsystem 113 includes a set of conventional I2C-compliant devices necessary to enable module 110 to provide a default level of automation functionality; such devices can include sensors, indicators, and switches. In the preferred embodiment, peripheral subsystem 113 includes a multi-spectral irradiance sensor (capable of separately sensing near-ultraviolet, near-infrared, and visible wavelengths); the use of such a multi-spectral irradiance sensor in automated window-shading applications is disclosed in U.S. Pat. No. 11,041,752. Optionally, peripherals subsystem 113 could include other sensors such as temperature sensors or a Passive-Infra-Red (PIR) motion sensor.

In addition to the electronic elements shown in the block diagram of FIG. 2, main module 110 also includes a conventional Printed Circuit Board (PCB) to connect the electronic elements, as well as conventional non-electronic elements necessary to implement a headrail-mounted blind automation device, such as a motor assembly, chassis, mounting PCB, and housing. Such elements are shown, for example, in U.S. Pat. No. 11,414,927. Notably, the embodiment of main module 110 shown in FIG. 2 does not contain a power source (e.g. a battery).

Instead, power for main module 110 is provided from a source external to module 110 via connector 116, left interface 114, or right interface 115.

Connector 116 is typically used to accept power from a mains-powered switching supply or a window-mounted photovoltaic panel, and is intended to be connected to the power source at the time of installation of main module 110 on the host blind and to be thereafter left connected to the power source indefinitely. In the preferred embodiment, connector 116 is a conventional ribbon-cable connector with four terminals.

On the other hand, interfaces 114 and 115 are intended to enable connection to an external power source after main module 110 has been mounted on the host blind, and to enable convenient breaking and re-establishing of a power connection thereafter. Inductive power transfer, as used in wireless charging applications, is ideal for transferring power under such circumstances. However, appropriate physical connectors offer greater transfer efficiency at lower cost.

Thus, interfaces 114 and 115 can be physical connectors or inductive power receivers. In an exemplar embodiment, interfaces 114 and 115 are conventional circular concentric magnetic pogo-pin connectors of the female gender, such as the female version of HytePro part number HTP-CON-M423. Connectors of this type are advantageous in this application because they are self-aligning, insensitive to angular displacement about the mating axis, provide a magnetic retention force, and offer greater transfer efficiency and lower cost than possible with inductive power transfer. However, an alternative embodiment using inductive power transfer may be preferable in some applications, and is described elsewhere in this disclosure.

Daughter-card connector 117 is a conventional four-terminal connector which includes four contacts, such that connector 117 can carry power, ground, serial transmit, and serial receive signals to enable exchange of power and serial TTL communication signals with microcontroller 111. Daughter-card connector 117 is configured to mate with a corresponding connector of an optional conventional daughter-card which includes an RF transceiver, and which thereby enables wireless connectivity to be conveniently added to main module 110. This also enables main module 110 to be compatible with a variety of wireless standards (e.g. WiFi, Zigbee, Bluetooth Low Energy, LoRaWAN, etc.) via the choice of daughter-card.

With the exception of interfaces 114 and 115, top connector 116, and daughter-card connector 117, the electronic configuration of main automation module 110 is that of a conventional blind-automation device: microcontroller 111 executes conventional firmware-encoded instructions (in addition to novel instructions described elsewhere in this disclosure) to control a motor, via motor controller 112, on the basis of information from peripheral subsystem 113 and, optionally, information received from an external device connected to connector 116 (via the I2C interface) or information received on a wireless daughter-card connected to daughter-card connector 117. The details of the automation provided by module 110 in this way are incidental to the subject invention, but generally include two types of conventional functionality. First, module 110 is capable of adjusting the host blind's slat-tilt angle in response to external commands, e.g. as transmitted from a smart device, voice-assistant, or home-automation system. Second, module 110 is capable of automatically adjusting the host blind's slat-tilt angle in response to changing conditions (e.g. to block direct sunlight).

With the exception of interfaces 114 and 115, top connector 116, and daughter-card connector 117, the physical configuration of main module 110 is also consistent with that of conventional devices which use a motor to actuate the tilt-control shaft of a wand-operated venetian blind, such as embodiments of the headrail-mounted motorized blind actuator shown in FIGS. 8 and 25-27 of U.S. Pat. No. 11,414,927. Practitioners are referred to that disclosure for detailed information relevant to the physical implementation of main module 110.

FIGS. 3 and 4 show a perspective view of an embodiment of main module 110: FIG. 3 shows a front perspective view, while FIG. 4 shows a rear perspective view.

FIGS. 3 and 4 both show a housing 130, a sensor window 131 in housing 130, and a slot 132 in housing 130. Housing 130 encloses the elements of main module 110 described with reference to FIG. 2. Sensor window 131 enables light to penetrate housing 130 to reach sensors in peripherals subsystem 113 of FIG. 2 (not visible in FIG. 3 or 4). As previously stated, peripherals subsystem 113 includes an irradiance sensor which responds to near-ultraviolet, visible, and near-infrared wavelengths, so sensor window 131 should be formed from a material which has acceptable transmittance from near-ultraviolet to near-infrared wavelengths. Slot 132 allows a ribbon cable to pass through housing 130 to connect to top connector 116 (not shown) of main module 110.

FIG. 3 shows left interface 114, while FIG. 4 shows right interface 115. It can be seen that interfaces 114 and 115 are bilaterally disposed in main module 110.

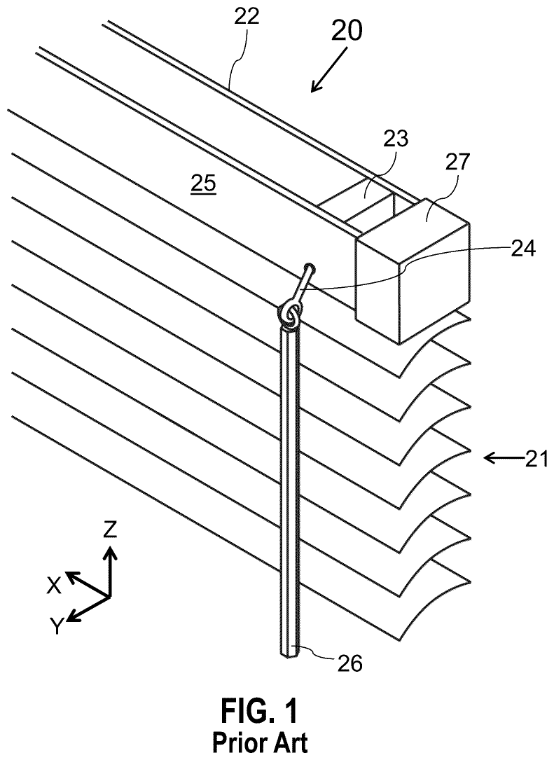

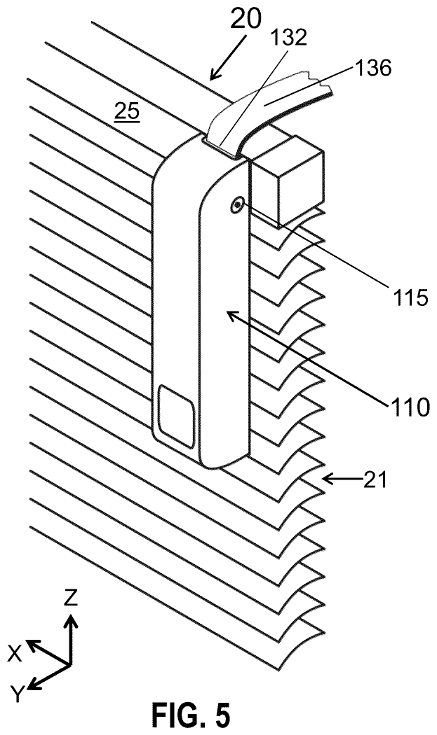

FIG. 5 shows a perspective view of an embodiment of main module 110 mounted on blind 20 of FIG. 1 to automate the latter's slat-tilt function. Module 110 is secured to headrail front 25 via magnets (not shown in FIG. 5), and a motor (not shown), inside housing 130 and controlled by motor controller 112 of FIG. 2, is coupled to the blind's tilt-control shaft as described in detail in aforementioned U.S. Pat. No. 11,414,927. Right interface 115 is visible, but is not used to provide power. Instead, a ribbon cable 136 emerges from slot 132; one end of cable 136 has a connector which mates with top connector 116 of FIG. 2 (not shown in FIG. 5), while the other end of cable 140 is attached to a device (not shown) which provides power and (optionally) receives or transmits information via an I2C interface. Such a device could be, e.g., a window-mounted solar-charged battery supply which includes a temperature sensor, or it could be a mains-powered switching power supply.

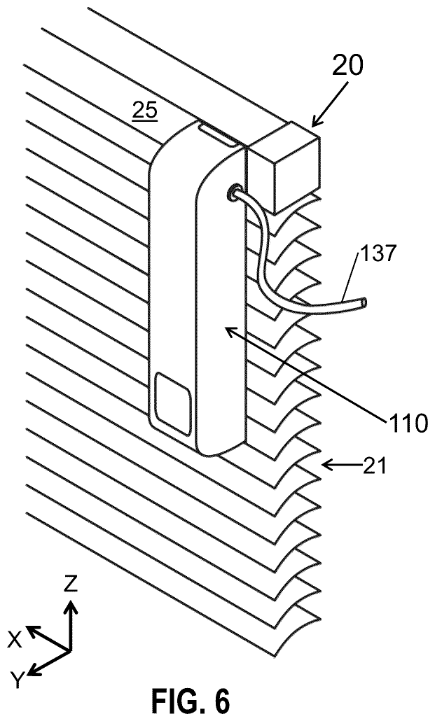

FIG. 6 shows a perspective view of an embodiment of main module 110 mounted on blind 20 in the same way as in FIG. 5, except that power is provided via right interface 115 (not shown) through a power cable 137, instead of via a ribbon cable connected to top connector 116 (not shown). Referring again to FIG. 3, power cable 137 could alternatively be connected to left interface 114 in the same way.

Thus, power can be supplied to main module 110 via a ribbon cable connected to top connector 116, a cable connected to left interface 114, or a cable connected to right interface 115. This provides significant flexibility in powering module 110, but does require installation of a cable.

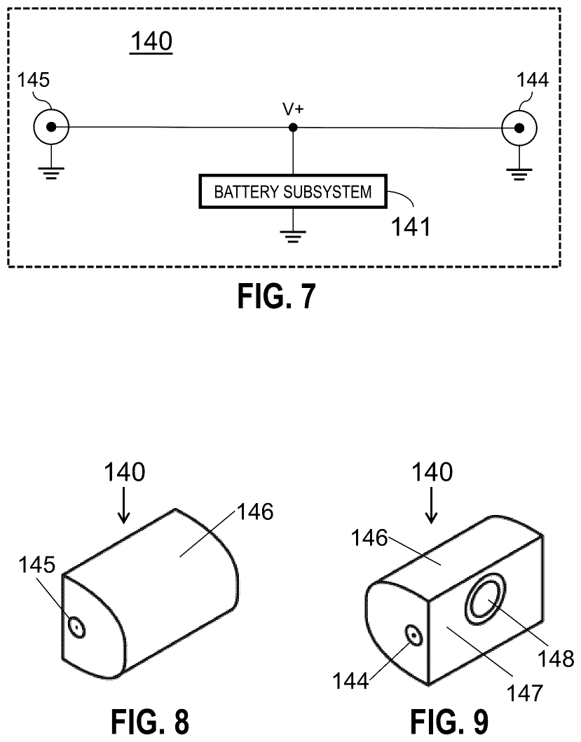

Battery Module 140. Main module 110 can be powered without need for cables via an external battery module, a battery module 140, whose block diagram is shown in FIG. 7. Battery module 140 includes a battery subsystem 141, a right interface 144, and a left interface 145. Battery subsystem 141 is a conventional subsystem which includes a battery holder and batteries. Right interface 144 is configured to be capable of mating with and supplying power to left interface 114 of main module 110, and left interface 145 is configured to be capable of mating with and supplying power to right interface 115 of main module 110. In the preferred embodiment, interfaces 144 and 145 are conventional circular concentric magnetic pogo-pin connectors of the male gender, such as the male version of HytePro part number HTP-CON-M423.

Thus, referring to both FIGS. 2 and 7, battery module 140 can supply power to main module 110 via either the mated combination of interface 114 and interface 144, or the mated combination of interface 115 and interface 145.

The physical configuration of battery module 140 is shown in perspective in FIGS. 8 and 9: FIG. 8 shows a front perspective view, while FIG. 9 shows a rear perspective view.

Battery module 140 has a housing 146 (FIG. 8) which encloses the elements of module 140 referenced in FIG. 7, as well as a chassis 147 and a magnet 148 (FIG. 9). Magnet 148 is a mounting magnet attached to chassis 147, which in turn supports housing 146 and the elements of module 140 referred to in FIG. 7. Also visible are left interface 145 (FIG. 8) and right interface 144 (FIG. 9).

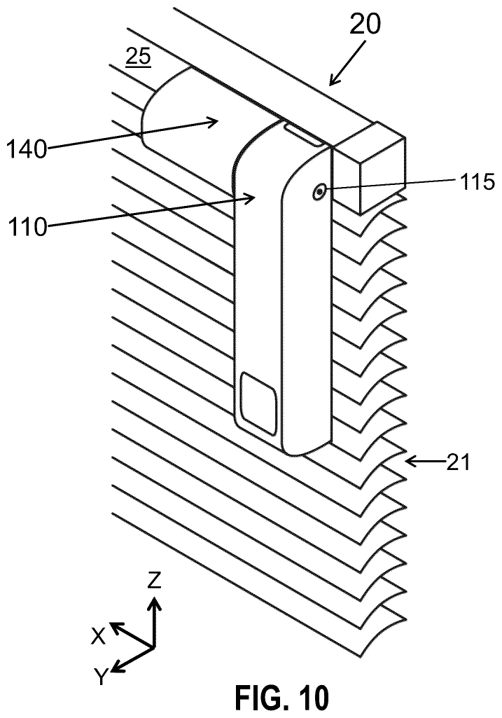

FIG. 10 shows a perspective view of main module 110 and battery module 140 mounted on blind 20 of FIG. 1, with battery module 140 supplying power to main module 110 via the mated combination of interface 114 and interface 144 (neither of which are visible in FIG. 10). As in FIGS. 5 and 6, main module 110 is mounted to blind 20 and held to headrail front 25 by magnets (not visible in FIG. 10) as described in the aforementioned U.S. Pat. No. 11,414,92. Battery module 140 is installed by placing it next to main module 110 so that its interface 144 mates magnetically with interface 114 of main module 110, and so that magnet 148 (also not visible in FIG. 10) adheres to headrail front 25.

However, while control shaft 24 protrudes from the right side of headrail 22 of blind 20 (as shown in FIG. 1), the control shaft instead protrudes from the left side of the headrail of many blinds. On such blinds, the arrangement of module 110 and battery module 140 shown in FIG. 10 (in which module 140 is mounted to the left of module 110) would be unworkable. Such a blind can be accommodated by mounting module 110 and module 140 to the host blind so that power is supplied via the mated combination of interface 115 and interface 145, instead of the combination of interface 114 and interface 144 as shown in FIG. 10.

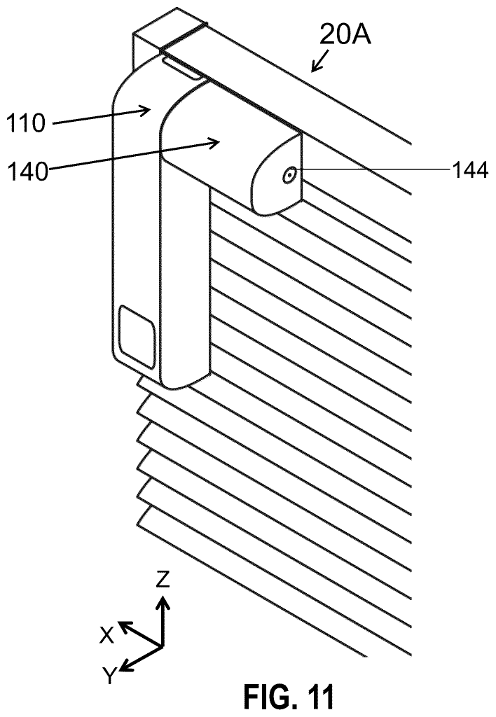

FIG. 11 shows a perspective view of such a mounting arrangement on a blind 20A. Blind 20A is equivalent to blind 20 of FIG. 1, except that its control shaft (not visible) protrudes from the opposite (left) side of the headrail. Module 110 and module 140 are attached to blind 20A in the same manner as they are attached to blind 20 in FIG. 10, except that their relative locations in the X-axis are reversed.

Thus, the pair of bilaterally disposed interfaces 114 and 115 of module 110, and the corresponding bilaterally disposed interfaces 144 and 145 of module 140, enable module 110 and module 140 to be used with blinds whose control shafts protrude from either side of the headrail. Further, as evident in FIGS. 9 and 10, the combination of main module 110 and battery module 140 is relatively compact and aesthetically pleasing, no wiring is needed between the battery module and main module, and battery module 140 is easily removable and re-installable to permit battery replacement. Finally, the location of the batteries in module 140 rather than module 110 minimizes the height (the Z-axis dimension) of module 110, mitigating potential issues due to headrail lean.

Solar Power Module 150. Unfortunately, in some applications, neither cable-supplied power (per FIG. 5 or 6), nor power via primary batteries (per FIG. 10 or 11) is acceptable. Many commercial automated blind products offer a window-mounted solar panel as an optional power source, but such panels also require a cable between the host product and the solar panel, and the mounting of the panel itself complicates the system installation.

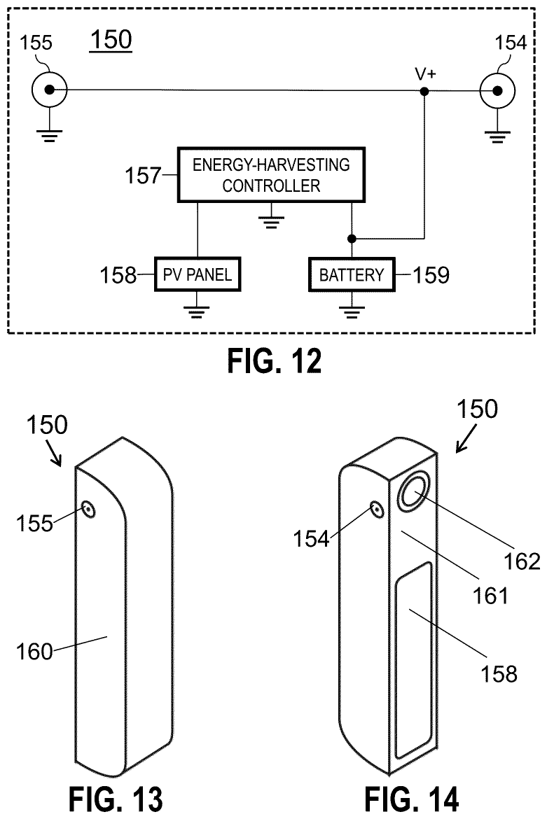

Main module 110 can be used in such applications—while avoiding the disadvantages of conventional window-mounted solar power panels—via the addition of a module analogous to battery module 140, but which derives power from a photovoltaic source. Such a module is a solar power module 150, whose block diagram is shown in FIG. 12. Solar power module 150 includes a right interface 154, a left interface 155, an energy-harvesting controller 157, a Photo-Voltaic (PV) panel 158, and a battery 159. In addition to the electronic elements shown in the block diagram of FIG. 12, module 150 also includes conventional elements such as a Printed Circuit Board (PCB) to interconnect the electronic elements.

Right interface 154 is configured to be capable of mating with and supplying power to left interface 114 of main module 110, and left interface 155 is configured to be capable of mating with and supplying power to right interface 115 of main module 110. In the preferred embodiment, interfaces 154 and 155 are of the same type as interfaces 144 and 145 of battery module 140, i.e. conventional circular magnetic pogo-pin connectors such as the male version of HytePro part number HTP-CON-M423.

Controller 157 is a conventional energy-harvesting controller, ideally with Maximum Power-Point Tracking (MPPT) capability (such as the Texas Instruments bq25570). Controller 157 is connected to PV panel 158 and battery 159 in a conventional manner, e.g. as described in the bq25570 data-sheet. Notably, the V+ terminals of interfaces 154 and 155 are connected directly to battery 159, and not to the output of the bq25570's buck regulator; thus, solar power module 150 provides unregulated battery voltage to an external device via interfaces 154 or 155. This enables microcontroller 111 of main module 110 (FIG. 2) to monitor the state of charge of battery 159, as described subsequently in this disclosure. However, in alternative embodiments of solar power module 150 it may be preferable to supply regulated power via interfaces 154 or 155, and instead provide battery charge status information via a hardwired or wireless interface.

PV panel 158 and battery 159 are conventional devices which can be selected according to conventional practice in the implementation of solar-charged battery supplies, except for certain unique considerations to be described subsequently. In the preferred embodiment, PV panel 158 is of the amorphous silicon type and battery 159 is of the Lithium-Ion Polymer (LiPo) type.

Thus, referring to FIGS. 2 and 12, solar power module 150 is configured to be able to supply power to main module 110 via either the mated combination of interface 114 and interface 154, or the mated combination of interface 115 and interface 155.

The physical configuration of solar power module 150 is shown in perspective in FIGS. 13 and 14: FIG. 13 shows a front perspective view, while FIG. 14 shows a rear perspective view.

Solar power module 150 has a housing 160 (FIG. 13) which encloses the elements of power module 150 referenced in FIG. 12, as well as a chassis 161 and a magnet 162 (FIG. 14). Magnet 162 is a mounting magnet attached to chassis 161, which in turn supports housing 160 and the elements of power module 150 described in reference to FIG. 12. Also visible are left interface 155 (FIG. 13) and right interface 154 (FIG. 14). Chassis 161 has a cut-out through which PV panel 158 is exposed (FIG. 14).

Referring to FIG. 14, PV panel 158 is positioned near the bottom of chassis 161, which minimizes shading of PV panel 158 by the window header or headrail of the host blind (not shown).

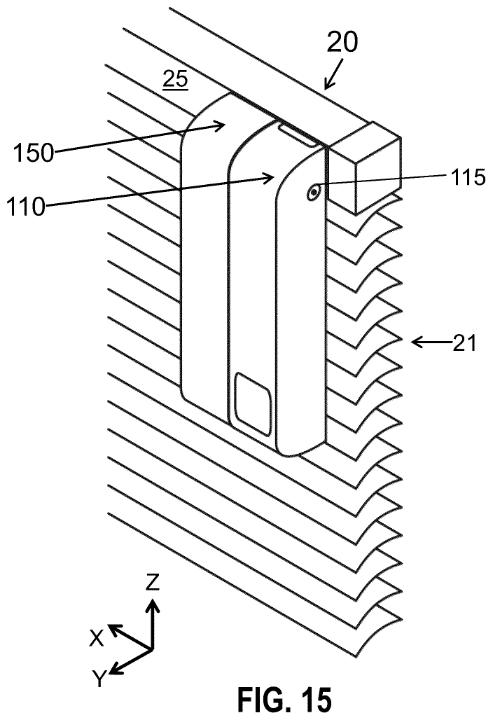

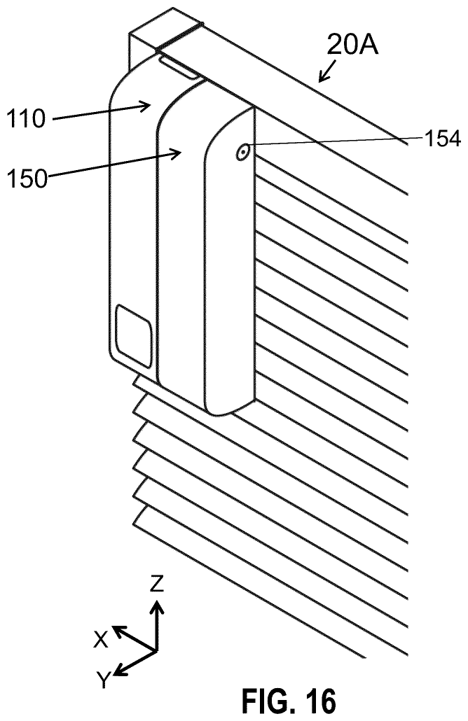

FIGS. 15 and 16 show perspective views of main module 110 and solar power module 150 mounted on blind 20 (FIG. 15) and blind 20A (FIG. 16). In each case, module 110 is attached to the host blind as previously described, and solar power module 150 is attached to the host blind as previously described for battery module 140. In the former case, solar power module 150 supplies power to main module 110 via the mated combination of interface 114 and interface 154, while in the latter case power is supplied via the mated combination of interface 115 and interface 155. Thus, the bilaterally disposed pair of interfaces 114 and 115 of main module 110, along with interfaces 154 and 155 of solar power module 150, enable both types of blind to be accommodated. Further, because module 150 is positioned on the side of main module 110 opposite the proximal end of the headrail, any shading of PV panel 158 caused by the proximal side of the window frame is minimized.

Referring to FIGS. 15 and 16, a salient aspect of solar power module 150 is that PV panel 158 (visible in FIG. 14, but not in FIG. 15 or 16) is mounted so that its photosensitive surface (the surface of PV panel 158 visible in FIG. 4) is on the room side of blind 20, facing slats 21. Thus, PV panel 158 does not directly receive sunlight from the window; instead, sunlight must first pass through (or be reflected from) slats 21.

Such a positioning of a PV panel is contrary to conventional practice in solar-powered blind-automation devices (in which the PV panel is mounted on the window side of the blind, with its photosensitive surface facing away from the slats and toward the window), because it significantly reduces the irradiance on the panel and thus its power output. This is exacerbated by the fact that the slats are likely to be closed when the irradiance is highest (i.e. to control daylight glare); if the slats are tightly closed, the peak irradiance on the PV panel can be reduced by as much as two orders of magnitude.

However, the slats of a venetian blind do not have to be tightly closed to provide useful shading: a blind can provide significant shading with partly-open slats by redirecting the admitted irradiance away from the line-of-sight of a person in a typical seated or standing position. For example, a horizontal blind blocks direct sunlight most effectively when its slats are tilted so that the irradiance is redirected upward toward the ceiling, above the line-of-sight of room occupants. A horizontal blind can also provide significant shading when the slats are tilted to redirect the irradiance downward to the floor, below the line-of-sight of room occupants. Further, when the slats are partly open, the irradiance on a vertical surface facing the blind increases with proximity to the blind.

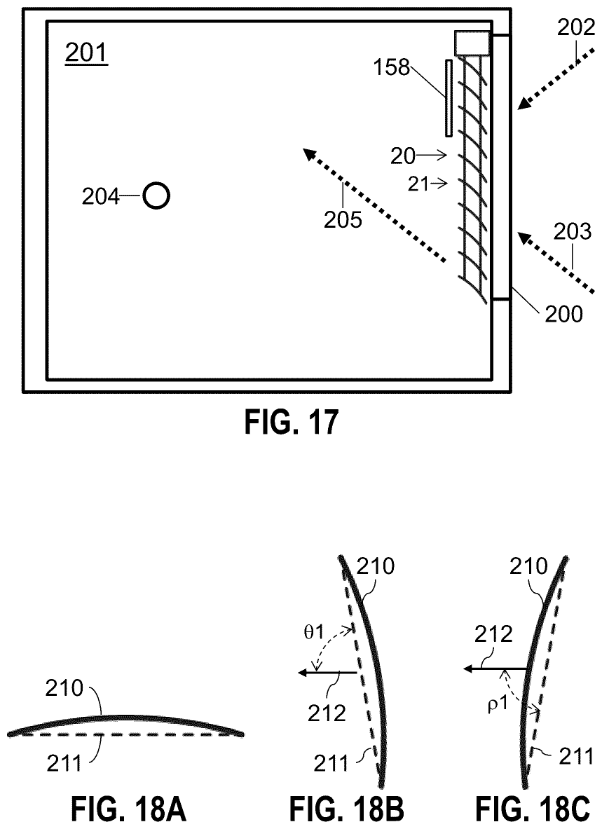

For example, FIG. 17 shows a side view of blind 20 mounted on a window 200 in a room 201. Two components of irradiance are incident on window 200: a direct skylight component 202 and a ground-reflected skylight component 203. A point 204 shows the typical relative location of an occupant's head, and a component 205 represents the irradiance admitted by the blind. Since direct sunlight component 202 will generally be strong enough to cause severe glare, slats 21 of blind 20 will typically be tilted so that component 205 is directed upward, so that it does not directly reach point 204. This slat orientation admits useful natural illumination but shields room occupants from severe daylight glare which would otherwise be caused by the direct sunlight component. However, it can be seen that if point 204 were moved higher or closer to blind 20, it would begin to intercept component 205 and therefore experience a significant increase in irradiance.

In fact, PV panel 158 is located high enough and close enough to the slats to fully intercept component 205. This upward component 205 includes ground-reflected component 203, as well as a portion of direct sunlight component 202 reflected upward from slats 21. The net irradiance of component 205 can thus be significant, even when the slats are almost fully closed. The same is true when the slats are tilted in the opposite direction, i.e. to direct irradiance downward.

Therefore, and despite the fact that component 205 strikes PV panel 158 obliquely, PV panel 158 can still generate substantial power when the slats are almost fully closed to block glare. Of course, the slats have a much smaller effect on the output power when they are in the open position (i.e. with a substantially horizontal orientation).

The net result is that a PV panel configured as PV panel 158 of FIG. 14, and located per the mounting of solar power module 150 shown in FIGS. 15 and 16, can receive enough average irradiance to power useful embodiments of main module 110 without requiring an unacceptably large panel area. This requires that the design of main module 110 is optimized in a conventional manner to minimize power consumption (e.g. by omitting wireless connectivity or by using a power-efficient RF protocol such as Zigbee), but offers the significant advantage that solar power module 150 is far easier to install than a conventional window-mounted solar panel, while also eliminating the need for unsightly wiring between the main module and the solar panel. A secondary advantage is that the reduction in peak irradiance increases the PV panel lifetime.

As previously noted, PV panel 158 and battery 159 can be chosen partly according to conventional practice, e.g. based on the expected average power consumption of the device being powered (i.e. main module 110 of FIG. 2) and typical insolation statistics. However, there are two unique considerations associated with the unique location and orientation of PV panel 158 with respect to the host blind and window.

First, panel 158 receives much less peak irradiance than typical outdoor solar panels, but much more irradiance—and over a broader spectrum—than typical indoor solar panels. Thus, panel 158 should employ a PV technology that is capable of operating with lower irradiance than typical outdoor panels, but there is no need to maximize efficiency at the wavelengths produced by LED or fluorescent lamps.

Second, referring again to FIG. 17, the irradiance on panel 158 will vary over the height of the panel due to shading from the individual slats. Therefore, if the panel comprises multiple series-connected PV cells, the height of each cell should ideally be greater that the width of the slats, in order to ensure that every cell receives some of the relatively high irradiance passing between the slats. This, in turn, will maximize the degree of blind closure at which the panel will still provide useful power.

Prototypes of solar power module 150 have successfully employed amorphous silicon PV panels with an individual cell height of approximately 40 millimeters.

Alternative Embodiment with PV Cell Incorporated in Main Module. The advantages of the unique configuration of PV panel 158 of solar power module 150 (i.e. the placement of panel 158 on the room side of the host blind facing the slats, rather than on the window side of the blind facing the window) are independent of the modular aspect of the subject invention (as enabled by the unique configuration of the bilaterally disposed connectors of the main module).

In fact, it may be preferable in some applications to integrate the functionality of main module 110 and solar power module 150 into a single self-contained automation device. Such a device would have the disadvantage of incurring the cost of the PV panel and battery even when mains-derived power or primary battery power would be acceptable, but would offer the advantages of simplicity and fewer stock-keeping units. Further, the costs of the PV panel and battery would be partially offset by the savings due to avoidance of the need for interfaces 114 and 115 and interfaces 154 and 155.

Blind Control Protocol to Maximize PV Energy Collection. As previously described in reference to FIG. 17, the proximity of PV panel 158 to slats 21 ensures that significant irradiance reaches PV panel 158 during daytime even when the slats are at least partly open. Further, when the slats are almost fully closed, even a slight opening of the slats will cause a relatively large increase in the irradiance on PV panel 158, with a relatively small impact on the blind's ability to provide shading or thermal insulation. This fact can be exploited to significantly increase the energy collected by PV panel 158, as described below.

The slats of a venetian blind can be tilted in either of two directions with respect to the “open” orientation (i.e. the slat orientation which admits the most light), such that a venetian blind has two “closed” positions. To illustrate this, FIGS. 18A-18C show a cross-sectional view of a slat 210 of a horizontal blind. FIG. 18A shows slat 210 in the open position, such that its chord 211 is substantially horizontal, while FIGS. 18B and 18C show slat 210 in two closed positions: in FIG. 18B, slat 210 has a tilt angle 01 between its chord 211 and an incoming horizontal light ray 212; in FIG. 18C, slat 210 has a tilt angle ρ1 between its chord 211 and ray 212.

The magnitudes of the “closed” tilt angles θ1 and ρ1 (and, thus, the amount of slat closure of the blind) are constrained by the mechanical design of the blind to somewhat less than 90 degrees. However, a blind automation device typically does not use the full mechanically-limited tilt range of the host blind. Instead, to avoid potential binding of the tilt mechanism, a typical blind-automation device uses programmable “soft limits” such that the magnitudes of θ1 and ρ1 (i.e. the amounts of slat closure at each soft limit) are less than the corresponding mechanical limits. In a conventional blind-automation protocol, the soft limits are established during a system set-up process: a user tilts the slats slightly short of a first of the two mechanical limits and then stores that tilt setting as the corresponding first soft limit (e.g. θ1); the process is then repeated by tilting the slats slightly short of the second mechanical limit and storing that tilt setting as the second soft limit (e.g. ρ1).

The power output of a PV panel such as panel 158 can be significantly increased by instructing the user to stop further short of the mechanical tilt limits during the set-up process, thereby by reducing the magnitudes of θ1 and ρ1 (i.e. the amount of slat closure at each soft limit). Alternatively, the system can automatically reduce the magnitudes of θ1 and ρ1 after the set-up process is complete, e.g. by multiplying the magnitudes by a predetermined fraction less than 1.0.

More advantageously, nearly the same increase in power output—but with a smaller impact on the blind's ability to provide shading or thermal insulation—can be obtained by automatically modifying the aforementioned soft limits (i.e. the amount of maximum slat closure) as a function of changing conditions.

This can be implemented by adding only a few steps to the conventional software operating steps performed by a blind-automation device, e.g. as executed by microcontroller 111 of main module 110 (FIG. 2). Such steps can be event-driven, or can be executed periodically. The following description of such steps assumes that the steps are inserted in a status-monitoring loop executed periodically by microcontroller 111 of main module 110 (FIG. 2).

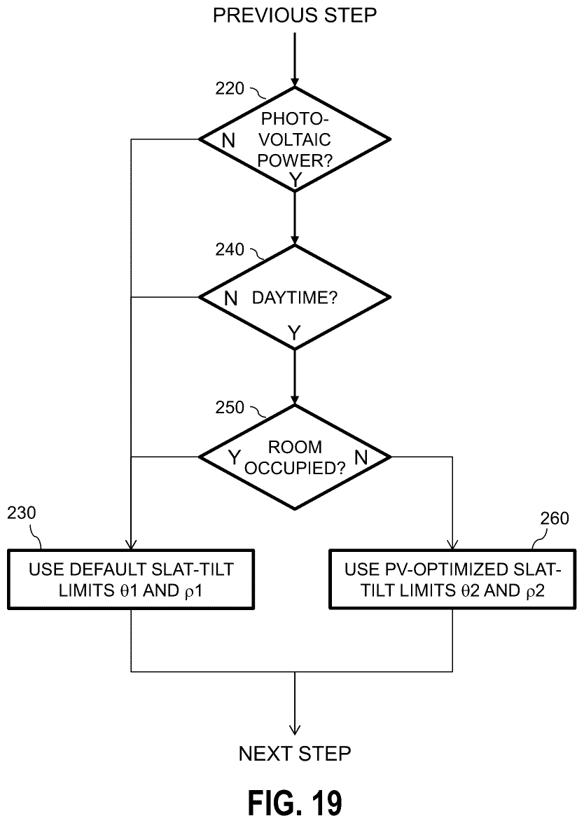

FIG. 19 is a flowchart of such additional steps. It assumes that default soft slat-tilt limits θ1 and ρ1 (FIGS. 18B and 18C respectively) have been established during a conventional system set-up process. Per conventional practice, these slat-tilt limits are such that that they represent a substantially closed position of the host blind, with the slats tilted close to their mechanical limits.

First, in an optional step 220, operation branches to one of two paths depending on whether the source of power for main module 110 is a PV panel (step 220 is not required in systems powered exclusively by a PV panel). In the preferred embodiment, the source of power is specified by a user using a menu in a conventional user interface; alternatively, it could be determined via a presence signal sent by a power source containing a PV panel.

If in step 220 it is determined that power is not being supplied by a PV panel, then operation proceeds to a step 230 in which the slat tilt limits are re-set to the default values θ1 and ρ1.

However, if in step 220 it is determined that power is being supplied by a PV panel (or in systems which are powered exclusively by a PV panel, in which case step 220 is omitted), operation proceeds to a step 240 in which the daytime/nighttime state is determined in a conventional manner, e.g. via the output of a light sensor or a real-time clock. If the nighttime state is determined, then operation proceeds to step 230.

Otherwise, if the daytime state is determined in step 240, operation proceeds to an optional step 250 in which operation branches depending on the occupancy of the room in which the blind is located (this step can be omitted if such information, e.g. from a Passive Infra-Red movement detector, is not available, or if the host room is expected to be regularly occupied in the daytime). If the room is occupied, operation branches to step 230.

However, if the room is not occupied (or if step 250 is omitted for the aforementioned reasons), operation proceeds to a step 260 in which a set of PV-optimized slat-tilt limits, defined by angles θ2 and ρ2, are selected instead of the default slat-tilt limits θ1 and ρ1, such that the magnitude of θ2 is less than that of 01 and/or the magnitude of ρ2 is less than that of ρ1, such that the maximum amount of slat closure is reduced. The optimal magnitudes of θ2 and ρ2 (and hence the reduction in the maximum amount of slat closure) depend on numerous design-specific and installation-specific variables, and should ideally be determined empirically. However, even a small reduction in the magnitudes of the tilt-angle limits, e.g. by just a few degrees, can yield a significant increase in the average power output of a PV panel such as panel 158.

After execution of either steps 230 or 260, operation proceeds to the next step in the conventional status-monitoring loop in which steps 220-260 have been inserted.

Thus, steps 220-260 in will cause the PV-optimized slat-tilt limits to be used when under PV power in the daytime when the host room is unoccupied, but the default slat-tilt limits to be used otherwise. This will significantly increase the average power output of a PV panel (such as panel 158 of FIG. 17) with minimal compromise in the blind's ability to provide shading or thermal insulation.

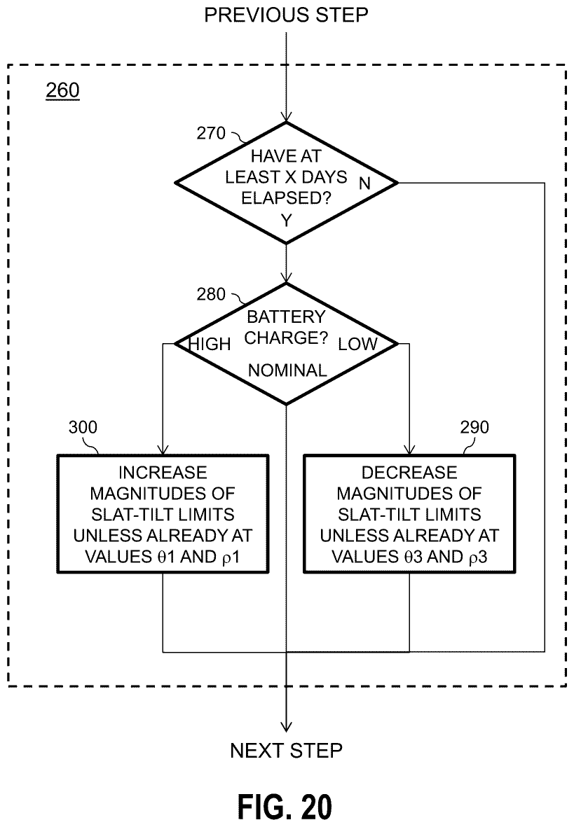

FIG. 20: Slat-Tilt Limits Adjusted as a Function of Battery Charge. The required photosensitive area of photovoltaic panel 158 of FIG. 12 can be reduced by dynamically adjusting the PV-optimized slat-tilt limits as a function of the state of charge of an energy-storage element, such as battery 159 of FIG. 12. This can be implemented via the steps shown in FIG. 20, which are intended to be performed within step 260 of FIG. 19.

First, in a step 270, operation branches to one of two paths depending on the number of days which have elapsed since the previous execution of step 270. If fewer than X days have elapsed, then operation proceeds to the next step in the conventional periodic loop in which steps 220-260 have been inserted; otherwise, operation proceeds to a step 280. The choice of parameter X will be discussed subsequently.

Step 280 branches to one of three paths depending on the level of charge of battery 159. Referring again to FIG. 2, the level of charge is determined in a conventional manner via sense voltage V_{X} provided to microcontroller 111 by regulator 118. Alternatively, the level of charge could be determined via a conventional coulomb-counting approach, e.g. using a battery-gauge integrated circuit in solar power module 150, but this would require a means of exchanging charge information between modules 110 and 150 (as is provided in other embodiments described herein).

If the battery charge is lower than a threshold (indicating that PV panel 158 is not collecting enough solar energy to offset the energy being drained from battery 159), then a step 290 is performed in which the magnitudes of the slat-tilt limits are reduced by an amount (e.g. a few degrees) unless the tilt limits have already been reduced (through previous executions of step 290) to values θ3 and ρ3. Values θ3 and ρ3 represent the minimum acceptable amounts of slat closure in the positive and negative tilt directions, respectively, in the fully-closed positions. The magnitudes of θ3 and ρ3 will depend on the preferences of the user, and are preferably user-defined in a modified version of the previously-described conventional set-up process in which soft-tilt limits θ1 and ρ1 are defined. Optionally, a warning can be issued on a user interface to indicate an insufficient battery charge if the slat-tilt limits have already been reduced to the minimum acceptable magnitudes of θ3 and ρ3.

However, if in step 280 the battery charge is found to be greater than a threshold (indicating that PV panel 158 is collecting more than enough solar energy to offset the energy supplied by battery 159), then operation branches to a step 300 in which the which the magnitudes of the slat-tilt limits are increased by an amount (e.g. a few degrees) unless the tilt limits are already at default values θ1 and ρ1.

Finally, if in step 280 the battery charge is found to be nominal (indicating that PV panel 158 is collecting just enough solar energy to offset the energy being drained from battery 159), then the slat-tilt limits are not changed.

After execution of either steps 290 or 300, or if in step 280 the battery charge is determined to be nominal, operation proceeds to the next step in the conventional status-monitoring loop in which steps 220-260 of FIG. 19 have been inserted.

Thus, steps 270-300 of FIG. 20, when performed within step 260 of FIG. 19, will adjust the slat-tilt limits every X days (per step 270) to maintain, to the extent possible, a nominal charge of battery 159. Prototypes have successfully used a value of 7 for X (so that the slat-tilt limits are adjusted no more frequently than every week).

Alternative Embodiment of Battery Module with Single Interface. In the previously-described embodiments, interfaces 114, 115, 144, 145, 154, and 155 are circular concentric magnetic pogo-pin connectors which are insensitive to rotation about the mating axis.

Because of this, it is possible to implement battery module 140 with only a single interface, instead of a pair of bilaterally disposed interfaces as shown in FIGS. 8 and 9.

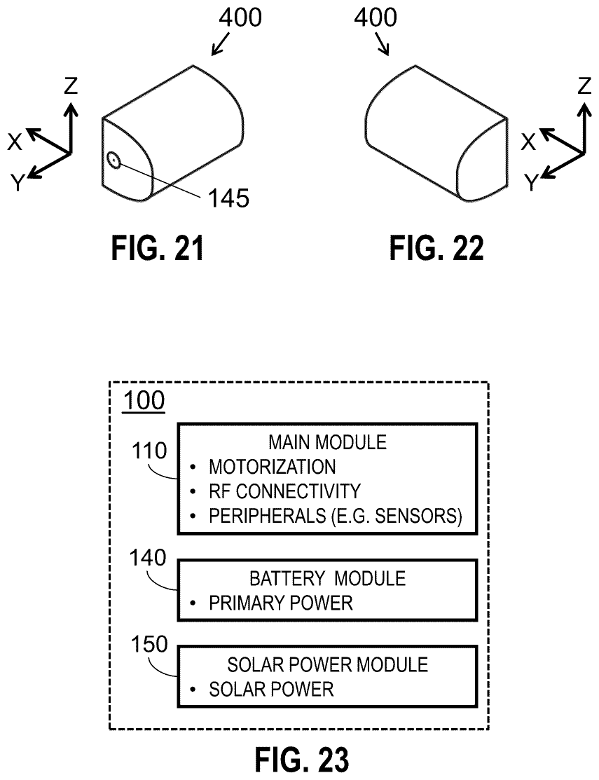

FIGS. 21 and 22 show front and rear perspective views, respectively, of such a battery module, battery module 400, which is identical to battery module 140 except that right interface 144 of module 140 (as shown in FIG. 8) is omitted. Module 400 can still be mounted on either side of main module 110 (as shown in FIGS. 10 and 11), by rotating module 400 by 180 degrees about the Y-axis. This eliminates the need for one interface, but requires that the physical configuration of the battery module be symmetric about the X-Y plane, and that it be no taller (in the Z-dimension) than the headrail of the host blind. Unfortunately, practical implementations of a solar power module (such as solar power module 150) cannot meet such symmetry and height constraints, so two interfaces are still required for solar power module 150.

Alternative allocation of functionality between modules. As summarized in FIG. 23, the previously described modules form a module family 100 consisting of main module 110, battery module 140, and solar power module 150, in which main module 110 provides all of the desired automation functionality except for a power source, while the auxiliary modules (modules 140 and 150) provide only power.

This allocation provides users with a choice of power source. Referring again to FIG. 2, it also provides users with the choice of whether or not to include RF connectivity (via inclusion or exclusion of an RF daughter-card connected to connector 117) and the choice of RF protocol (via the type of daughter-card connected to connector 117). However, this allocation requires that all purchasers of main module 110 pay for the functionality provided by peripherals subsystem 113, whether or not such functionality is desired.

Thus, it may be desirable to expand the module family with one or more auxiliary module types which either subsume some of the functionality of peripherals subsystem 113, or add functionality beyond that provided by peripherals subsystem 113. There are four fundamental considerations in expanding the number of module types.

The first consideration is the maximum number of auxiliary modules that will be used simultaneously with the main module. In the case of the module family 100 of FIG. 23, only one auxiliary module (i.e. either module 140 or module 150) can be used at the same time with module 110, which simplifies the module design. A requirement to be able to use two auxiliary modules at the same time complicates the design, and the design is further complicated if the design must support simultaneous use of three auxiliary modules.

The second consideration applies when the module family must support simultaneous use of two or more modules, as described above. In this case, the module design can become quite complex if the module family must be able to support all possible mounting arrangements of the modules. For example, when there are two auxiliary modules A1 and A2 to be used simultaneously with a main module M, there are four potential mounting arrangements depending on the side-by-side positioning of the modules: M-A1-A2, M-A2-A1, A1-A2-M, and A2-A1-M. The module design is complicated if all four arrangements must be supported, but relatively simple if only two arrangements must be supported.

The third consideration is whether any of the auxiliary modules require a physical design which is asymmetric about the horizontal plane and/or is taller than the height of the host headrail. For example, PV module 150 of FIG. 14 is both asymmetric about the horizontal plane and taller than the headrail, so it must always be mounted in the orientation shown in FIG. 14, i.e. with PV panel 158 below magnet 162. On the other hand, battery module 400 of FIGS. 21 and 22 has a physical design which is symmetric about the Y-Z (horizontal) plane and is no taller than the headrail, so that it can be flipped 180 degrees around the Y-axis and thereby mounted with interface 145 on either the left side or the right side. Including more than one auxiliary module which is asymmetric about the horizontal plane or taller than the host headrail greatly increases the complexity of designing an interoperable module family.

Finally, while a modular family of automation devices enables an automation system to be configured according to the specific needs of the user, development and distribution costs increase with the number of module types and their design complexity.

These considerations limit the number of modules which can be advantageously included in a family of modular headrail-mounted automation devices. However, the considerations do suggest two potentially advantageous modifications to the three-module family 100 shown in FIG. 23: allocation of some of the functionality of main module 110 to solar power module 150, or addition of a peripherals module to provide some of the functionality of main module 110 (or additional functionality).

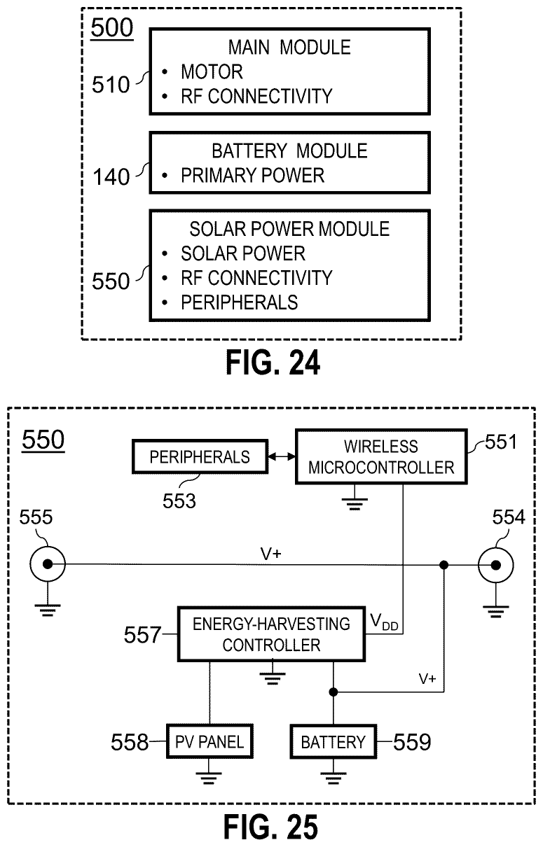

FIGS. 24 and 25: Solar Power Module with Peripherals Functionality. FIG. 24 shows a module family 500 in which a solar power module 550 includes the functionality provided by peripherals subsystem 113 of main module 110 (FIG. 2). Family 500 also includes a main module 510 and battery module 140.

Main module 510 is equivalent to main module 110 of FIG. 2, except that it omits peripherals subsystem 113 and connector 117, and that microcontroller 111 is preferably a System-on-Chip (SoC) wireless microcontroller with multi-protocol wireless support (such the Texas Instruments CC2652P7).

FIG. 25 shows a block diagram of solar power module 550, which is equivalent to solar power module 150 of FIG. 12 except for the addition of a wireless microcontroller 551 and a peripherals subsystem 553.

Peripherals subsystem 553 is equivalent to peripherals subsystem 113 of main module 110 of FIG. 2. Microcontroller 551 is a conventional wireless microcontroller (such as the Texas Instruments CC2651R3) capable of communicating wirelessly with the microcontroller of main module 510, and with an I2C interface capable of communicating with peripherals subsystem 553. Microcontroller 551 executes conventional firmware-encoded instructions to receive and respond to commands from main module 510.

Microcontroller 551 is powered by the regulated output of an energy-harvesting controller 557, which power is derived from a battery 559 which, in turn, is charged through controller 557 by a PV panel 558. Battery 559 can supply power, via an interface 554 or an interface 555, to an external device, i.e. main module 510. Interface 554, interface 555, controller 557, panel 558, and battery 559 are equivalent to interface 154, interface 155, controller 157, panel 158, and battery 159, respectively, of solar power module 150 (FIG. 12).

Solar power module 550 has the same physical configuration (not shown) of solar power module 150 of FIGS. 13 and 14, except for the addition of a sensor window equivalent to window 131 of main module 110 (FIGS. 3 and 4), which allows light to reach sensors in peripherals subsystem 553. Because solar power module 550 has a similar physical configuration to that of solar power module 150, it can be mounted to the host blind in the same way as module 150, e.g. as shown in FIGS. 15 and 16.

Thus, main module 510 and solar power module 550 work together in the same way as main module 110 and solar power module 150, except that the peripherals are located in solar power module 550 instead of in main module 510, and are accessed wirelessly by the microcontroller of main module 510, rather than via a wired I2C interface.

It would also be possible to use wired instead of wireless communications between main module 510 and solar power module 550. However, this would entail replacing all of the interfaces in module family 500 with connectors having at least two additional terminals, thereby increasing the cost and size of the connectors.

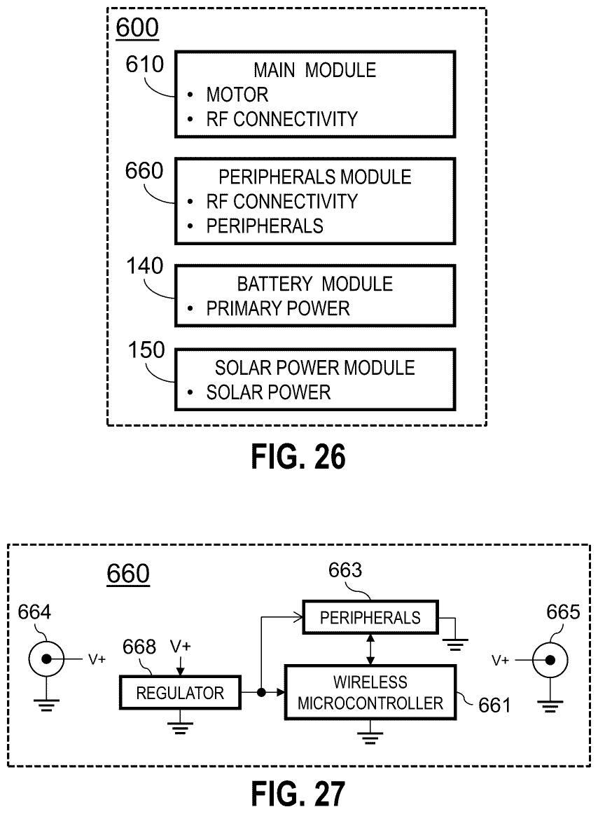

FIGS. 26 and 27: Peripherals Module. It is potentially advantageous to expand the module family by adding another type of auxiliary module, e.g. to provide the functionality of peripherals subsystem 113 of main module 110. Such a module family 600 is shown in FIG. 26. In addition to battery module 140 and solar power module 150, family 600 includes a main module 610 and a peripherals module 660.

Main module 610 is equivalent to main module 110 of FIG. 2, except that it omits peripherals subsystem 113 and connector 117, and microcontroller 111 is preferably a System-on-Chip (SoC) wireless microcontroller with multi-protocol wireless support (such the Texas Instruments CC2652P7).

As shown in the block diagram of FIG. 27, peripherals module 660 includes a wireless microcontroller 661, a peripherals subsystem 663, a left interface 664, a right interface 665, and a regulator 668.

Wireless microcontroller 661 and peripherals subsystem 663 are equivalent to microcontroller 551 and peripherals subsystem 553, respectively, of solar power module 560, and microcontroller 661 executes conventional firmware-encoded instructions similar to those executed by microcontroller 551.

Left interface 664 and right interface 665 are equivalent to left interface 114 and right interface 115 of main module 110 (FIG. 2). Thus, like interfaces 114 and 115, interfaces 664 and 665 are capable of mating with and receiving power from modules 140 or 150. In a preferred embodiment, interfaces 664 and 665 are conventional circular concentric magnetic pogo-pin connectors of the female gender, such as the female version of HytePro part number HTP-CON-M423.

Regulator 668 is equivalent to regulator 118 of main module 110 (FIG. 2). It receives unregulated power from an external device via either interfaces 664 or 665, and provides regulated voltage to microcontroller 661 and peripherals subsystem 663.

Microcontroller 661 can communicate wirelessly with an external device (e.g. main module 110) and via I2C with peripherals subsystem 663, and can thereby act as a bridge to enable main module 110 to access peripherals in peripherals subsystem 663.

There are no functionally-driven requirements on the form-factor of peripherals module 660, except that interfaces 664 and 665 must be bilaterally-disposed in the same way as interfaces 114 and 115 of main module 110 (FIGS. 3 and 4). Notably, like solar power modules 150 and 550, the physical configuration of peripherals module 660 need not be symmetric in the horizontal plane and can be taller than the height of the headrail of the host blind. However, for aesthetic reasons, it is advantageous to make the form-factor of module 660 the same as that of battery module 140. In the preferred embodiment, peripherals module 660 has the same physical configuration as battery module 140 of FIGS. 8 and 9, except for the addition of a sensor window (to be described subsequently).

A salient difference between peripherals module 660 on one hand, and battery module 140 and solar power modules 150 on the other hand, is that the former receives power while the latter two modules supply power. This constrains the possible mounting arrangements of the modules in module family 600. Specifically, at least one of battery module 140 or solar power module 150 is necessary in order to use peripherals module 660, and the power module must be installed between main module 110 and peripherals module 660.

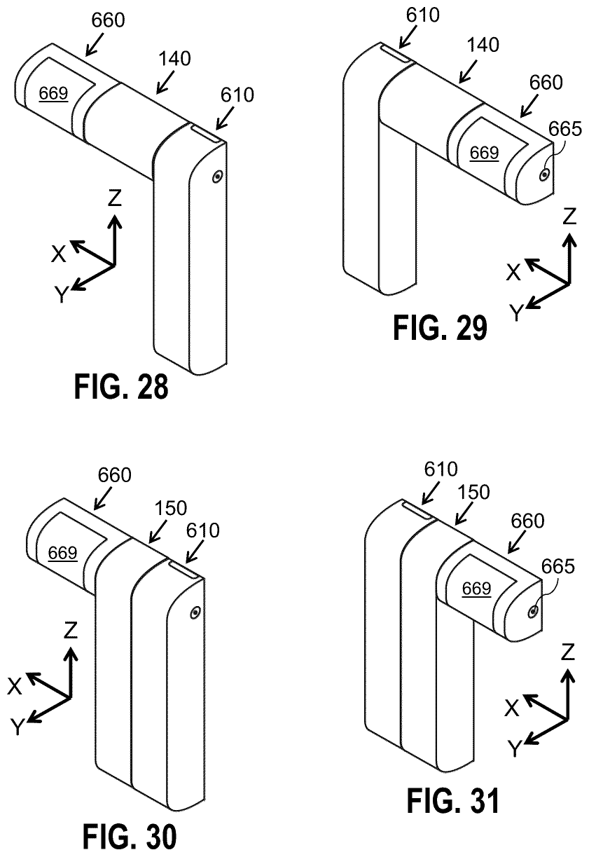

Thus, when module 660 is being used with main module 110, there are four possible mounting arrangements as shown in FIGS. 28-31: FIG. 28 shows modules 660 and 140 attached to the left side of module 610, FIG. 29 shows modules 660 and 140 attached to the right side of module 610, FIG. 30 shows modules 660 and 150 attached to the left side of module 610, and FIG. 31 shows modules 660 and 150 attached to the right side of module 610.

FIGS. 28-31 show a sensor window 669 of peripherals module 660 (similar to sensor window 131 of main module 110 as shown in FIGS. 3 and 4) to admit light to sensors in peripherals subsystem 663.

FIGS. 29 and 31 show right interface 665 of module 660; left interface 664 is not shown.

In FIGS. 28 and 30, module 660 receives power via right interface 665 (not shown), and in FIGS. 29 and 31, module 660 receives power via left interface 664 (not shown). Thus, bilaterally disposed interfaces 664 and 665 enable module 660 to be mounted on either side of the module which powers it.

In addition to the arrangements of FIGS. 28-31, main module 610 can still be used without peripherals module 660—or either battery module 140 or solar power module 150—by accepting power from another source via a connector equivalent to top connector 116 of main module 110 (FIG. 2). Also, peripherals module 660 can be used with either battery module 140 or solar power module 150—but without main module 110—to wirelessly provide sensor functionality to another device, such as home-automation hub.

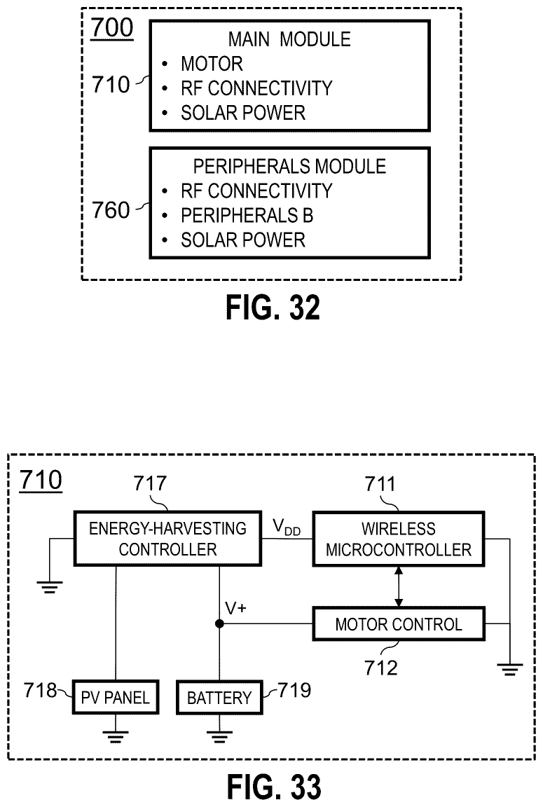

FIG. 32: Module Family with PV Power and without Physical Interfaces. As previously stated, it can be advantageous to integrate the solar-power generation functionality of solar power module 150 into a main module analogous to main module 110. Extending this further, every module in a module family can have its own solar-charged battery supply and wireless networking capability, thereby eliminating the need for physical interfaces and allowing greater flexibility in the relative placement of the modules.

FIG. 32 shows such a module family 700 in which each module has its own solar power supply and the capability for wireless communications; it includes a main module 710 and a peripherals module 760. Main module 710 provides a default level of functionality which can be increased via the addition of peripherals modules 760.

For example, main module 710 could provide only enough functionality to adjust the slats of the host blind in response to commands received from a user interface or home-automation hub, while peripherals module 760 could provide additional functionality to enable main module 710 to operate autonomously to minimize energy consumption. For example, peripherals module 760 could include a multi-spectral irradiance sensor (capable of separately sensing near-ultraviolet, near-infrared, and visible wavelengths); the use of such a multi-spectral irradiance sensor in automated window-shading applications is disclosed in U.S. Pat. No. 11,041,752. Optionally, peripherals module 760 could include other sensors such as temperature sensors or a Passive-Infra-Red (PIR) motion sensor.

FIG. 33 shows a block diagram of main module 710. It includes a wireless microcontroller 711, a motor controller 712, an energy-harvesting controller 717, a PV panel 718, and a battery 719. Panel 718 and battery 719 are equivalent to panel 158 and battery 159, respectively, of solar power module 150 (FIG. 12). As previously described for main module 110, main module 710 also includes conventional elements such as a gear-motor to actuate a host blind's tilt-control shaft.

Microcontroller 711 is preferably a System-on-Chip (SoC) wireless microcontroller with multi-protocol wireless support (such the Texas Instruments CC2652P7) and which is capable of actuating motor controller 712. Microcontroller 711 executes conventional firmware instructions equivalent to those executed by microcontroller 111 to automate the slat-tilt function of a host blind, in addition to unique instructions as described in this disclosure and additional conventional instructions to enable main module 711 to wirelessly issue commands to, and receive response from, another module.

Energy-harvesting controller 717, PV panel 718, and battery 719 function as do controller 157, panel 158, and battery 159 (respectively) in solar-power module 150, supplying regulated voltage to microcontroller 711 and unregulated battery voltage to motor controller 712.

The physical configuration of main module 710 is similar that of main module 110 (FIGS. 3 and 4), except that it omits elements analogous to interfaces 114 and 115, window 131, and slot 132, and that PV panel 718 is located as is PV panel 158 of solar power module 150 (FIG. 14). Main module 710 can therefore be mounted on the host blind, with its motor output shaft coupled to the host blind's tilt-control shaft, in the same way as main module 110, and with PV panel 718 on the room side, and facing the slats, of the host blind.

Thus, main module 710 is powered by solar power and can adjust the slat-tilt of the host blind in response to commands received wirelessly by microcontroller 711. This enables a user to operate the blind remotely, e.g. via a smartphone, and also enables automatic operation (e.g. on the basis of time-of-day) via commands sent from a home-automation hub or building-automation system. This level of automation functionality will be sufficient for many users.

However, when greater automation functionality (e.g. the ability to operate autonomously without need for a home-automation hub) is needed, main module 710 can be augmented with peripherals module 760.

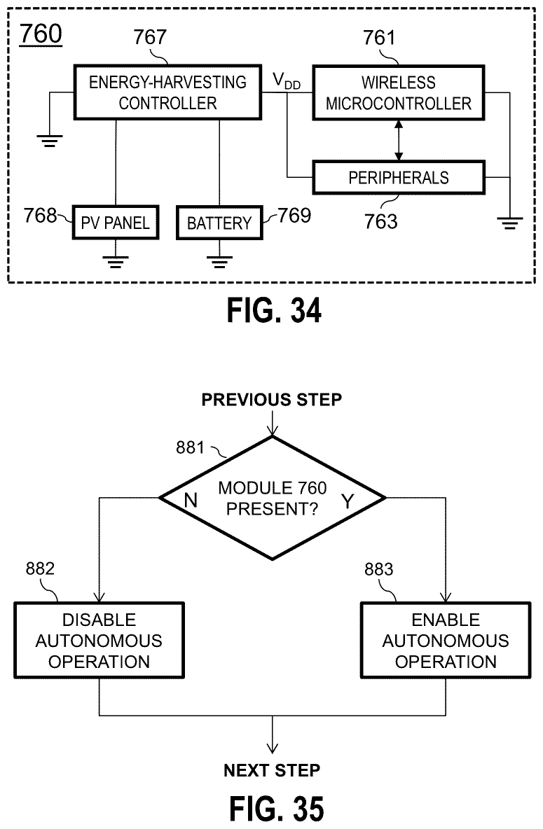

FIG. 34 shows a block diagram of peripherals module 760. It includes a wireless microcontroller 761, a peripherals subsystem 763, an energy-harvesting controller 767, a PV panel 768, and a battery 769. Controller 761 is equivalent to wireless microcontroller 661 of peripherals module 660 (FIG. 27).

Panel 768, and battery 769 are equivalent to controller panel 158 and battery 159, respectively, of solar power module 150 (FIG. 12), but can be sized differently according to the power consumption of module 760 (per conventional practice). Peripherals subsystem 763 is equivalent to peripherals subsystem 663 of peripherals module 660 (FIG. 27) and includes a multi-spectral illuminance sensor.

Energy-harvesting controller 767, PV panel 768, and battery 769 function in the same way as controller 157, panel 158, and battery 159 (respectively) do in solar-power module 150, supplying regulated voltage to microcontroller 761 and peripherals subsystem 763. Microcontroller 761 functions in the same way as microcontroller 661 of module 660 (FIG. 27): it can communicate wirelessly with an external device (e.g. main module 710) and via I2C with peripherals subsystem 763, and can thereby act as a bridge to enable main module 710 to access the multi-spectral illuminance sensor of peripherals subsystem 763. Microcontroller 761 executes conventional firmware-encoded instructions to receive and respond to commands from main module 710 and to operate peripherals in peripherals subsystem 763.

The physical configuration of peripherals module 760 is similar to that of solar power module 150 (FIGS. 13 and 14), enabling module 760 to be mounted on the host blind in the same way as module 150.

Referring again to FIG. 33, microcontroller 711 performs conventional operations to adjust the slat-tilt of the host blind (via motor controller 712) in response to wireless commands, e.g. from a home-automation hub. In addition to these conventional operations, microcontroller 710 also periodically performs the operations of the flowchart of FIG. 35. First, in a step 881, microcontroller 711 ascertains the presence of module 760 in a conventional manner; e.g. via a wireless network registry. If module 760 is not present, a step 882 is performed to reset an autonomous-operation flag to disable autonomous operation.

However, if module 760 is present, then a step 883 is performed to set the autonomous-operation flag to enable autonomous operation. If the autonomous-operation flag is set, then microcontroller 711 periodically polls peripherals subsystem 763 of module 760 to measure the irradiance in at least two spectral bands. Microcontroller 711 then uses this information to adjust the slat-tilt angle of the host blind to control glare under changing conditions, as described in U.S. Pat. No. 11,041,752. Optionally, peripherals subsystem 763 can also include a temperature sensor or a Passive Infra-Red (PIR) movement sensor, enabling microcontroller 711 to make slat-tilt adjustments on the basis of temperature and room occupancy.

Further Alternative Functional Allocations. In module family 100 of FIG. 23, only main module 110 includes a peripherals subsystem, while in module families 500 (FIG. 24), 600 (FIGS. 26) and 700 (FIG. 32) the main module omits a peripherals subsystem, which is located instead in an auxiliary module.

However, in many applications it will be advantageous to split some peripheral functionality between the main module and an auxiliary module. For example, peripherals which are relatively small or inexpensive could be included in the main module, with larger or more expensive peripherals included in an auxiliary module. As another example, the peripherals in the main module could be optimized for a relatively large market segment, while those in an auxiliary module could be aimed at meeting the needs of a smaller market segment. The modular aspect of the subject invention facilitates such optimization.

Alternative Types of Interface. In the above-described embodiments, interfaces 114, 115, 144, 145, 154, 155, 554, 555, 664, and 665 are physical connectors which are used to exchange power. Specifically, interfaces 144, 145, 154, 155, 554, and 555 are conventional circular two-terminal magnetic pogo-pin connectors (such as HytePro part number HTP-CON-M423) of the male gender, and interfaces 114, 115, 664, and 665 are corresponding connectors of the female gender.

However, additional terminals could be added to exchange signals in addition to (or instead of) power. This can eliminate the need for wireless connectivity between a main module and an auxiliary module (when signals in addition to power must be exchanged), but increases the size and cost of the connectors and precludes wireless communications with devices outside the module family (e.g. a home-automation hub).

Other connector types could also be used, such as in-line magnetic pogo-pin connectors, coaxial barrel-type connectors, or USB Type-C power connectors. USB Type C power connectors and coaxial barrel-type connectors are significantly less expensive, but magnetic pogo-pin connectors facilitate attachment and detachment and will provide a better user experience.

Referring again to FIG. 31, the magnetic pogo-pin connectors of the aforementioned embodiments mate along the X-axis. A potentially advantageous variation is to orient the connectors so that they instead mate along the Y-axis.

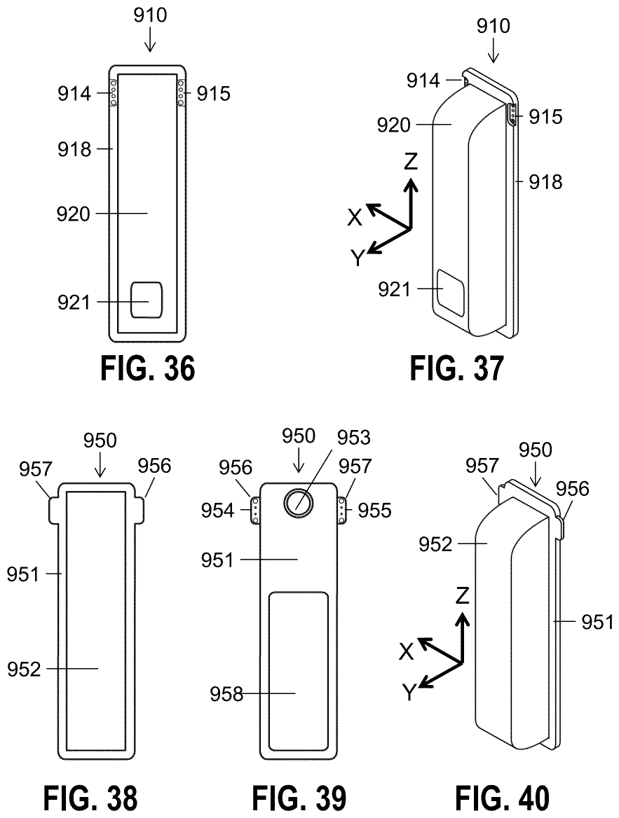

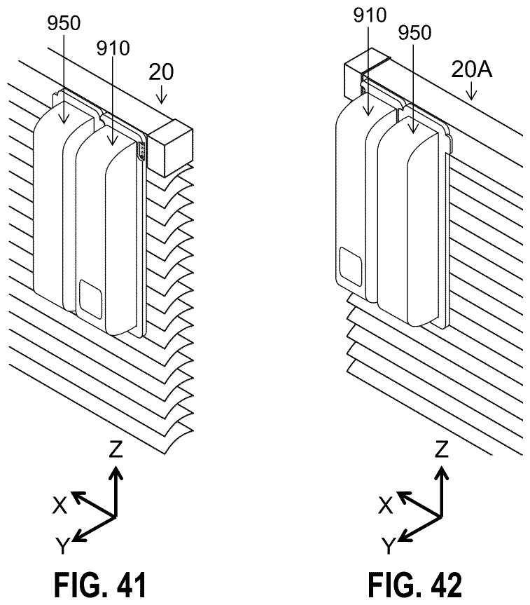

FIGS. 36-42 show the physical configurations of two such embodiments with Y-axis-mating connectors: FIGS. 36 and 37 show front and front-perspective views, respectively, of a main module 910; FIGS. 38-40 show front, front perspective, and rear views, respectively, of a solar power module 950; and FIGS. 41 and 42 show front perspective views of modules 910 and 950 attached together.

Main module 910 (FIGS. 36 and 37) is equivalent to main module 110 of FIGS. 2-4 except for the type and orientation of interfaces and chassis configuration. As shown in the front view of FIG. 36, module 910 has a left interface 914 and a right interface 915 located in the rim of a chassis 918 from which a removable housing 920 protrudes in a direction perpendicular to the drawing plane; an optical window 921 is in housing 920. Chassis 918 is of 3D-printed or injection-molded plastic. A PCB (not visible) within housing 920 and mounted on chassis 918 interconnects interfaces 914 and 915 together and to the other electronic elements of main module 910. Interfaces 914 and 915 are two-terminal inline magnetic pogo-pin connectors of the female gender, such as Mill-Max Manufacturing Corporation part number 878-20-002-00-011000. Housing 920 and window 921 are equivalent to housing 130 and window 131 of main module 110 (FIGS. 3 and 4). Main module 910 also has a mounting magnet (not shown) on the underside of chassis 918 which is equivalent to magnet 162 of solar power module 150 (FIG. 14).

As shown in the perspective view of FIG. 37, left interface 914 and right interface 915 are inset into recesses in chassis 918, and are oriented with their mating surfaces pointed in the Y-axis direction so that they can mate with corresponding male-gender connectors along the Y axis. This is in contrast to, e.g., right interface 115 of main module 110 (FIG. 5), which mates along the X-axis.

Solar power module 950 is equivalent to solar power module 150 of FIGS. 12-14 except for the chassis configuration and type and orientation of interfaces. As shown in the front view of FIG. 38, module 950 has a chassis 951 with a right ear 956 and a left ear 957. A removable housing 952 protrudes from chassis 951 in a direction perpendicular to the drawing plane. Chassis 918 is of 3D-printed or injection-molded plastic.

FIG. 39 is a rear view of module 950 showing that it has a mounting magnet 953, a right interface 954, a left interface 955, and a PV panel 958 mounted to chassis 951. Right interface 954 is inset into ear 956 while left interface 955 is inset into ear 957. Magnet 953 and PV panel 958 are equivalent to magnet 162 and panel 158 of solar power module 150 (FIGS. 13 and 14). Interfaces 954 and 955 are interconnected by a PCB (not shown), within housing 952 and mounted on chassis 951, to each other and to the other electronic elements of module 950. Interfaces 954 and 955 are two-terminal inline magnetic pogo-pin connectors of the male gender, such as Mill-Max Manufacturing Corporation part number 878-22-002-10-011101, and are configured to mate with interfaces 914 and 915 of main module 910.

FIG. 40 is a front perspective view showing the same elements of module 950 shown in the front view of FIG. 38. Referring to both FIGS. 39 and 40, it can be seen that the interfaces 954 and 955 are oriented so that they mate along the Y-axis, with their mating surfaces on the rear side of module 950.

FIG. 41 shows main module 910 and solar power module 950 in an operational configuration, connected together and mounted on blind 20 with module 950 on the left side of module 910. In this configuration, right interface 954 (visible in FIG. 39 but not FIG. 41) of module 950 is mated with left interface 914 (visible in FIG. 36 but not FIG. 41) of module 910. This is conveniently achieved by first mounting module 910 to blind 20 in the same way as previously described for module 110 (FIG. 5), moving module 910 into position in the X-Z plane, and then moving it toward the headrail of blind 20 in the negative-Y-axis direction until the aforementioned interfaces mate magnetically and magnet 953 (visible in FIG. 39) adheres to the headrail of blind 20.

FIG. 42 shows main module 910 and solar power module 950 in a second operational configuration, connected together and mounted on blind 20A with module 950 on the right side of module 910. In this configuration, right interface 915 (visible in FIG. 37 but not FIG. 42) of module 910 is mated with left interface 955 (visible in FIG. 39 but not FIG. 42) of module 950. The mounting procedures for module 910 and 955 in this configuration are the same as for the configuration of FIG. 41.

An advantage of connectors which mate along the Y-axis (per the embodiments shown in FIGS. 41 and 42) over those which mate along the X-axis (per the embodiments shown in FIGS. 15 and 16) is that they facilitate attachment of the auxiliary module to the main module and host blind. However, the difference in ease of attachment is only modest, while the implementation is more complex.

Use of Electrostatic versus Electrochemical Energy Storage for Solar Power. The above-described embodiments of solar power supplies include electrochemical batteries (battery 159 of FIG. 12, battery 559 of FIG. 25, battery 719 of FIG. 25, and battery 769 of FIG. 34) of the Lithium-Ion Polymer (LiPo) type. However, as is known in the art of solar-charged power supplies, an alternative battery chemistry could be used, or the electrochemical battery could be replaced or augmented with an electrostatic storage device (e.g. a supercapacitor). In the context of this disclosure, the term “battery” used in connection with a solar power source is intended to refer to energy-storage devices in general which are capable of storing solar energy.

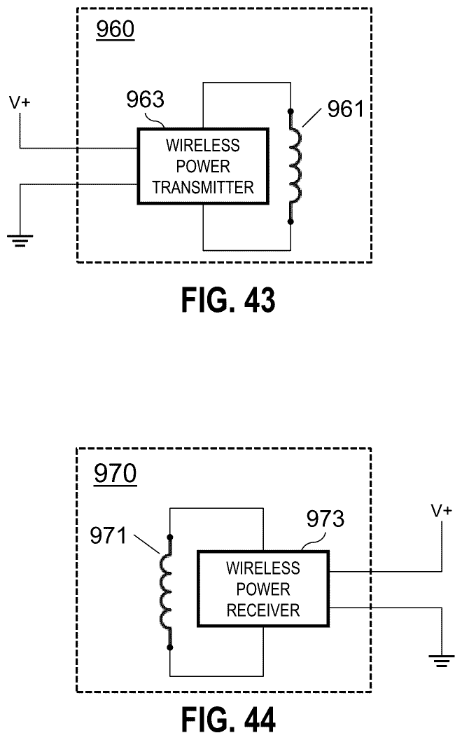

FIGS. 43 and 44: Use of Inductive Power Transfer in lieu of Physical Connectors. As previously stated, the inter-module interfaces of the above-described embodiments could be used to exchange signals as well as power. However, if they are used only to exchange power, then they can be implemented via an inductive power transfer mechanism rather than as physical connectors.

For example, in the above-described embodiments, interfaces 144, 145, 154, 155, 554, 555, 954, and 955 are physical connectors used to transmit power; these are referred to below as “transmit interfaces”. On the other hand, interfaces 114, 115, 664, 665, 914, and 915 are physical connectors used to receive power; these are referred to below as “receive interfaces”. The transmit interfaces could be implemented as near-field inductive power transmitters, while the receive interfaces could be implemented as near-field inductive power receivers.

For example, FIG. 43 shows a block diagram of a transmit interface implemented as a near-field inductive power transmitter 960. Transmitter 960 includes a conventional transmitter coil 961, a conventional power transmitter IC 963 (such as the Analog Devices LTC4125), and (not shown in FIG. 43) the discrete components required by IC 320 (as specified in the corresponding manufacturer's datasheet).

FIG. 44 shows a block diagram of a receive interface implemented as a near-field inductive receiver 970. Receiver 970 includes a conventional receiver coil 971, a conventional power receiver IC 973 (such as the Analog Devices LTC4120), and (not shown in FIG. 44) the discrete components required by IC 340 (as specified in the corresponding manufacturer's datasheet).

As is known in the art of inductive power transfer, the transmit and receive coils are flat and must be in close proximity to achieve reasonable power transfer efficiency. This is facilitated by the physical configurations of most of the module embodiments described herein. For example, referring again to FIG. 15, this is because the modules have flat sides (i.e. in the Y-Z plane), which enables the transmitter and receiver coils to be located coaxially within 1 cm of each other when the modules are mounted side-by-side on the host blind (e.g. as shown in FIGS. 15 and 16). Thus, an instance of power transmitter 960 could be substituted for any of physical transmit interfaces 144, 145, 154, 155, 554, and 555, and an instance of power receiver 970 could be substituted for any of physical receiver interfaces 114, 115, 664, and 665, by mounting the corresponding coils in the Y-Z plane immediately underneath the flat sides of the housing. This, in turn, enables relatively high power transfer efficiency, and the absence of physical connectors facilitates attachment and detachment of the modules from each other (and the host blind).

However, power transfer efficiency is still low compared to direct power transmission via physical connectors (i.e. approximately 50 percent versus virtually 100 percent), resulting in only half the battery life (or requiring twice the PV panel area) of the preferred embodiment with physical connectors. Also, the components required for inductive power transfer are significantly more expensive than physical connectors. For these reasons, it is expected that physical connectors would be preferred for most embodiments of the subject invention.

Alternative means of module mounting. While the module embodiments shown herein include mounting magnets for attachment to a host headrail, alternative means of mounting, e.g. adhesives or clamps, are also feasible.

Also, for an auxiliary module which is sufficiently light in weight, it can be advantageous to omit the mounting magnet for headrail attachment, and instead configure the auxiliary module for attachment solely to the main module. This can be done by using magnetic connectors with sufficiently strong magnets for the inter-module interfaces, or by using dedicated magnets in the main and auxiliary modules instead of (or in addition to) magnetic connectors. For example, referring to FIGS. 15 and 16, modules 110 and 150 could each include a pair of magnets disposed bilaterally along the x-axis, located toward the bottom (Z-axis) of the modules, and configured to provide an attractive force between module 110 and 150. Referring again to FIG. 14, this can eliminate the need for mounting magnet 162 of module 150.

Such use of dedicated magnets to provide an attractive force between modules along is particularly attractive when inductive power transfer is used (as previously described in reference to FIGS. 43 and 44), because it enables the modules to self-align for maximum power transfer.

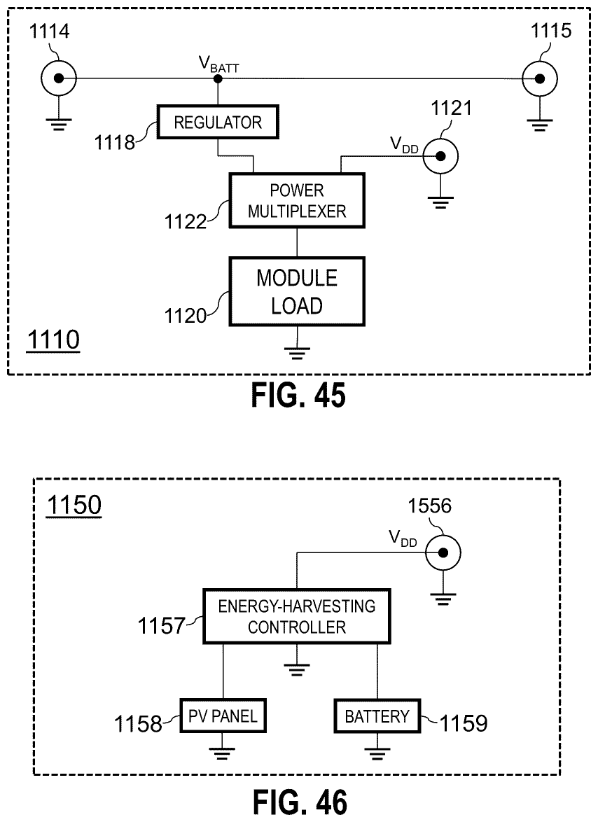

FIGS. 45 through 51: Main Module with Removable Photovoltaic Module. In module family 100 of FIG. 23, module family 500 of FIG. 24, module family 600 of FIG. 26, and module family 700 of FIG. 32, each module is a distinct assembly which is removably attached to a host headrail. Module families 100, 500, and 600 include separate main and solar power modules, while in module family 700, the main module incudes a photovoltaic panel.

Alternatively, it can be advantageous to have separate main and solar power modules in which the solar power module is removably attached to the main module and not directly to the host headrail.

FIG. 45 shows a block diagram of the electronic portion of such a main module 1110. It includes a left interface 1114, a right interface 1115, and a regulator 1118, which are respectively equivalent to interface 114, interface 115, and regulator 118 of main module 110 of FIG. 2. Interfaces 1114 and 1115 accept unregulated power from another module (e.g. battery module 140 of FIGS. 7-9) on V_{Batt} and ground terminals and provides it to regulator 118

Module 1110 also includes a module load 1120 which subsumes conventional power-consuming elements equivalent to microcontroller 111, motor controller 112, and peripherals subsystem 113 of main module 110.

Module 1110 further includes a conventional connector 1121 and a conventional power multiplexer 1122.

Connector 1121 accepts regulated power from an external source via a mating connector and provides it on V_{DD} and ground terminals. Connector 1121 can be of any type which provides a retaining force between itself and a mating connector; in the preferred embodiment, connector 1121 is a two-terminal inline magnetic pogo-pin type of the female gender, but coaxial and non-magnetic connectors could also be used.

Power multiplexer 1122 is conventional means of routing power from either of two input terminals to an output terminal according to predefined criteria. Specifically, multiplexer 1122 accepts power from the V_{BATT} terminal and routes it to load 1120 if there is no voltage on the V_{DD} terminal, but routes power from the V_{DD} terminal to load 1120 if there is voltage on the V_{DD} terminal. In a preferred embodiment, multiplexer 1122 is a TPS2115ADRBR Autoswitching Power Multiplexer manufactured by Texas Instruments, Inc., which also provides cross-conduction and reverse-conduction blocking.

Thus, if an external power source is connected to connector 1121 and is providing V_{DD}, power from that source is routed through multiplexer 1122 to power main module 1110 (whether or not V_{BATT} is non-zero). Otherwise, if V_{DD} is zero, voltage from the V_{BATT} terminal (if present) is used to power main module 110.

FIG. 46 shows a block diagram of the electronic portion of a solar power module 1150 for use with the above-described main module 1110. It includes an energy-harvesting controller 1157, a PV panel 1158, and a battery 1159 which are equivalent to controller 157, panel 158, and battery 159 of solar power module 150 of FIGS. 12-14. Solar power module 1150 also includes a conventional connector 1156 which mates with connector 1121 of main module 1110 to supply solar power thereto.

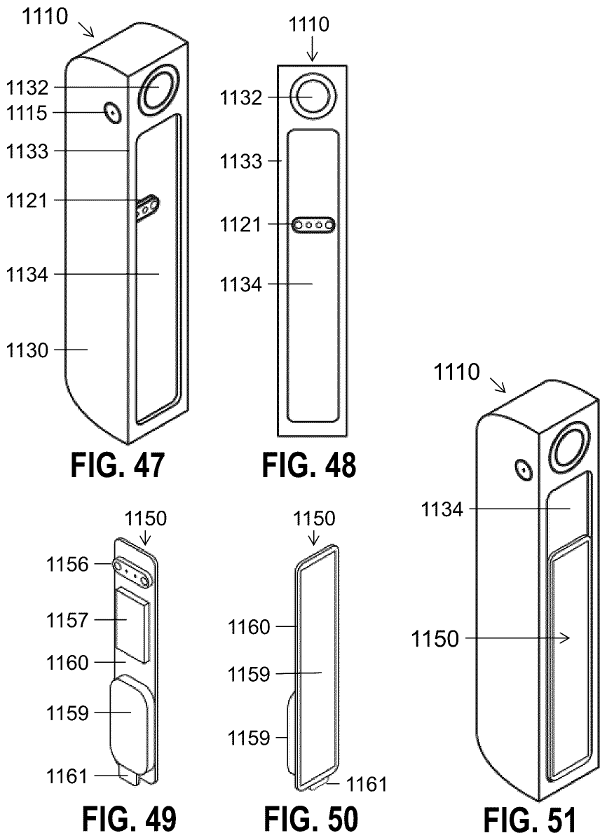

FIGS. 47 is a right rear perspective view of main module 1110, while FIG. 48 is a rear view. As shown in FIG. 47, in addition to right interface 1115, module 1110 also has a magnet 1132 mounted on a chassis 1133, and a housing 1130 that encloses the elements of module 1110 shown in the block diagram of FIG. 45. Chassis 1133 has a cutout 1134, through which connector 1121 is visible. Other elements of module 1110 which would be visible through cutout 1134 are incidental to this portion of the description and are omitted for the sake of clarity. The rear view of FIG. 48 also shows connector 1121, magnet 1132, chassis 1133, and cutout 1134 of module 1110.

FIG. 49 is a right front perspective view of solar power module 1150. In addition to connector 1156, energy-harvesting controller 1157, and battery 1159, it also shows a Printed-Circuit Board (PCB) 1160 and a tab 1161 attached to, and extending downward from, the front surface of PCB 1160.

FIG. 50 is a left rear perspective view of solar power module 1150. In addition to battery 1159, PCB 1160, and tab 1161, it also shows PV panel 1158 of FIG. 46.

FIG. 51 is a right rear perspective view of main module 1110 with solar power module 1150 attached thereto. Module 1150 fits within cutout 1134 of module 1110, and is secured by the mating of connectors 1121 (FIGS. 47) and 1156 (FIG. 49), as well as by tab 1161 (FIGS. 49 and 50) lodged behind the bottom edge of cutout 1134 (FIG. 47).

In operation, main module 1110 with solar power module 1150 attached (per FIG. 51) would be mounted on a host blind in the same way as previously described for module 110 and blind 20 (FIG. 5).

Note that there is sufficient area in cutout 1134 above solar power module 1150 (FIG. 51) for control shaft 24 of blind 20 (FIG. 1) to be coupled to a gear-motor within main module 1110 (not shown), e.g. per embodiments shown in U.S. Pat. No. 11,414,927.

The advantage of the configuration of FIGS. 45-51 is that it enables solar-powered operation within a single module footprint (as is the case with module 700 of FIG. 32), but also avoids the cost of the components needed for solar power if battery power is used instead (as is the case with module 110 of FIGS. 2-6). A connector analogous to top connector 116 of main module 110 (FIG. 2) could also be included to provide hardwired power to main module 1110, if so desired.

Batteries mounted in main module. In the module families described previously, main modules 110, 510, 610, 710, and 1110 omit batteries in order to minimize weight and volume. However, a battery holder could be included in any of the main modules (in lieu of a separate battery module such as module 140 of FIGS. 7-11). Although increasing the weight and volume of the main module, this would reduce cost by reducing the number of required interfaces or connectors.

Window coverings other than blinds. While the subject invention is particularly advantageous in the context of horizontal venetian blinds, certain aspects are of the invention are also advantageous in the context of other types of window covering incorporating headrails.

I claim:

1. An electronic device for a window-shading device having a headrail, said electronic device having at least two interfaces for receiving power, said electronic device configured to be attached to said headrail with said interfaces disposed bilaterally along said headrail.

2. The electronic device of claim 1 wherein said interfaces are connectors of the magnetic pogo-pin type.

3. The electronic device of claim 1 wherein said interfaces are inductive power receivers.

4. An electronic device for a venetian blind mounted on a window in a room; said blind having a headrail, a room-facing side, and a window-facing side; said device including a power source with a photosensitive surface; and said device is configured to attach to said headrail on said room-facing side with said photosensitive surface facing said window.

5. The device of claim 4 in which said power source includes an energy-storage element having a level of charge, and in which said device includes a controller to adjust the slat-tilt angle of said blind over a range delimited by a closed setting which depends on said level of charge.

6. A system to automate a venetian blind, said system receiving power from a power source, said system including a controller to tilt the slats of said blind over a range delimited by a closed setting which depends upon whether said power source includes a photovoltaic panel.

7. The system of claim 6 wherein said closed setting defines an amount of slat closure which is decreased if said power source includes a photovoltaic panel.

8. The system of claim 6 wherein said closed setting defines an amount of slat closure which is increased if said power source does not include a photovoltaic panel.

9. The system of claim 6 wherein said power source includes an energy-storage device having a level of charge, and said closed setting depends on said level of charge if said power source includes a photovoltaic panel.
